(19) United States
(12) Patent Application Publication
(10) Pub. No.: US 2006/0259419 A1
(43) Pub. Date: Nov. 16, 2006

(54) Financing structure

(76) Inventors: Gordon L. Monsen, Riegelsville, PA (US); Joseph C. Yiu, Basking Ridge, NJ (US)

Correspondence Address: WILLKIE FARR & GALLAGHER LLP;INTELLECTUAL PROPERTY LEGAL ASSISTANTS, 787 SEVENTH AVE, NEW YORK, NY, 10019-6099, US

(21) Appl. No.: 10/549,983

(22) PCT Filed: Mar. 19, 2004
(86) PCT No.: PCT/US04/08361

§ 371 Date: Feb. 21, 2006

Related U.S. Application Data
(60) Provisional application No. 60/455,754, filed on Mar. 19, 2003.

(51) Int. Cl. G06Q 40/00

(52) U.S. Cl. 705/38

(57) ABSTRACT

A junior loan made by a junior lender to an owner/lessor of commercial real estate. Ownership of the real estate and of a lease of the real estate may be arranged in one or more special-purpose entities bankruptcy remote from obligations unrelated to the real estate. The junior loan may be collateralized at least in part by a pledge to the lender of rent cash flows generated by the lease and a junior assignment of rents under the lease. The junior lender may forego any mortgage foreclosable against the real estate, any ownership interest in any entity with an ownership interest in the real estate, the lessor of the lease, or a tenant of the real estate, except at most in the event of bad boy acts and force majeur events. The owner may surrender over to a lockbox arrangement the right to rents. The lockbox may be obligated to make a senior payment to the senior lender and a junior payment to the junior lender before the owner receives any residual of the lease payments. The lockbox may be structured to isolate payment risk to the credit of the tenant. The junior loan may have a payment priority senior to all other obligations of the lessor except a senior loan. Pricing of the junior loan may be based on the credit of the tenant. The principal of the loan may be guaranteed by a financial derivative arranged to cover default of the tenant on rents under the lease.

This application claims priority from U.S. Provisional Application Ser. No. 60/455,754, filed Mar. 19, 2003, incorporated herein by reference.

### BACKGROUND

This invention relates to contractual structures for commercial loans and real estate leases.

In secondary loans (e.g., “home equity loans” or “secondary mortgages”) on owner-occupied residential real estate, the secondary lender obtains a right to foreclose on the real estate, subject to the senior lender's right to first payment out of the proceeds of any foreclosure.

In contrast, subordinate lending to owners of commercial real estate is relatively rare. Subordinate loans (also known as “mezzanine loans” or “junior loans”) typically require a complex inter-creditor agreement between the senior lender, the junior lender, the lessor, and the tenant. A typical inter-creditor agreement reduces the senior lender's right to foreclose and take over the property until the mezzanine lender has had the opportunity to cure a default by the tenant, or may either allow or obligate the mezzanine lender to operate the property. If any one of these parties finds that his position is worsened by the proposed agreement, he has the power to block the entire deal. Similarly, an inter-creditor agreement may leave the junior lender with too many obligations or an insufficient collateral position. For example, in order to lend, a junior lender might require a lien on the property. In this case, the senior lender typically observes that the lien reduces his collateral position, and he blocks the deal.

In many mezzanine loan deals, the senior lender is concerned with the mezzanine lender “becoming the borrower.” The senior lender underwrote the property and the credit and real estate expertise of the owner/borrower, and may be reluctant to establish a contractual relationship in which, in the event of default, repayment of the senior loan may turn on the real estate management skills of the mezzanine lender.

Consequently, owners of commercial real estate have had limited ability to borrow against their real estate or the equity that they may have in the real estate. Generally, mezzanine lending rates range from 12-13% where the aggregate capitalization is below 80% to more than 20% where these levels exceed 90%.

### BRIEF SUMMARY

In general, in a first aspect, the invention features a financing structure. A junior loan is owed by an owner of commercial real estate to a junior lender. Ownership of the real estate and of a lease of the real estate are arranged in one or more special-purpose entities bankruptcy remote from obligations unrelated to the real estate. The owner owes a senior loan to a senior lender and the junior loan to the junior lender. The owner surrenders over to a lockbox arrangement the right to rents paid by a tenant under the lease. The lockbox is obligated to make a senior payment to the senior lender and a junior payment to the junior lender before the owner receives any residual of the lease payments. The lockbox is structured to isolate payment risk to the credit of the tenant. A pricing of the junior loan is based on the credit of the tenant.

In general, in a second aspect, the invention features a financing structure. A junior loan and senior loan are made to an owner of commercial real estate. The junior loan is collateralized at least in part by a junior assignment of rents under the lease in lieu of a mortgage foreclosable by the junior lender against the real estate. The junior assignment is junior to any assignment of rents to the senior lender.

In general, in a third aspect, the invention features a financing structure. A loan is made by a lender to an owner of commercial real estate. The real estate is under lease from the owner to a tenant. The principal of the loan is guaranteed by a financial derivative arranged to cover default of the tenant on rents under the lease.

In general, in a fourth aspect, the invention features a financing structure. A junior loan is made by a junior lender to an owner of commercial real estate. The owner of the real estate and of a lease of the real estate surrender over to a lockbox arrangement the right to rents paid under the lease. The lockbox is obligated to make a senior payment to a senior lender and a junior payment to the junior lender before the owner receives any residual of the lease payments. The junior loan is collateralized by a pledge to the lender of rent cash flows generated by a lease of the real estate, and neither a pledge nor a lien over the real estate nor against any ownership interest in any entity with an ownership interest in the real estate, except at most in the event of bad boy acts and force majeur events.

In general, in a fifth aspect, the invention features a financing structure. A junior loan from a lender to an owner of an interest in real estate is subordinate to a senior financing of the real estate/The junior loan is collateralized by a pledge to the lender of rent cash flows generated by a lease of the real estate. The terms of the junior loan are non-recourse against the real estate, the lessor of the lease, or a tenant of the real estate, except at most in the event of bad boy acts and force majeur events.

In general, in a sixth aspect, the invention features a financing structure. A junior loan from a junior lender to a owner of an interest in real estate has a payment priority that is senior to all other obligations of the owner except a senior loan. The junior loan is non-recourse against the real estate, the owner, or a tenant of the real estate except at most bad boy acts and force majeur events.

In general, in a seventh aspect, the invention features a financing structure. A lender lends funds to create a junior loan from a lender to a owner of real estate, the real estate being under lease from the owner to a tenant. The junior loan is subordinate to a senior loan owed by the owner. An interest rate of the junior loan being based on the credit of the tenant.

Embodiments of the invention may include one or more of the following features. At least one step of originating, managing or servicing the loan may be performed with the assistance of a computer. Under the terms of the junior loan, in the event of default by the tenant, the owner may covenant to surrender rents under any replacement lease to the lockbox arrangement. The lockbox arrangement may includes two different servicers or custodians of different depository accounts for servicing the junior and senior loans, respectively. Alternatively, a single servicer may make the payments to the senior and junior lenders from a single depository account. The lockbox arrangement may make a payment for operating expenses or taxes before the owner receives any residual of the lease payments. The junior loan may be entered under an existing senior loan, or may be entered contemporaneously with the senior loan. Terms of the junior loan may have the effect of imposing requirements on the tenant in event the tenant enters bankruptcy and reaffirms the lease. Terms of the lease may obligate the tenant to continue to pay rent in the case of at least a partial condemnation taking, and terms of the loan provide recovery to the junior lender against any recovery by tenant or landlord for the condemnation. The lease may be a single-tenant lease, or a lease of a multi-tenant property.

The junior lender may issue obligations backed by the payments from the lockbox arrangement. The obligations may include a private placement participating or syndicating the loan. The obligations may include a publicly-issued security. At least part of the junior payment may be reserved in an over-collateralization account for the protection of the obligations. The junior lender may secures a put, short, swap, insurance, or other protection against default of the tenant.

The above advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

FIG. 1 is an entity cash-flow diagram.

FIG. 2, comprising FIGS. 2a-2e, is a term sheet for an example Tripartite Mezzanine Loan.

FIG. 3 is a table comparing properties of two capitalization structures.

FIG. 4 is a graph plotting cash flows against time.

FIG. 5 is a flow chart.

### DESCRIPTION

I. Overview

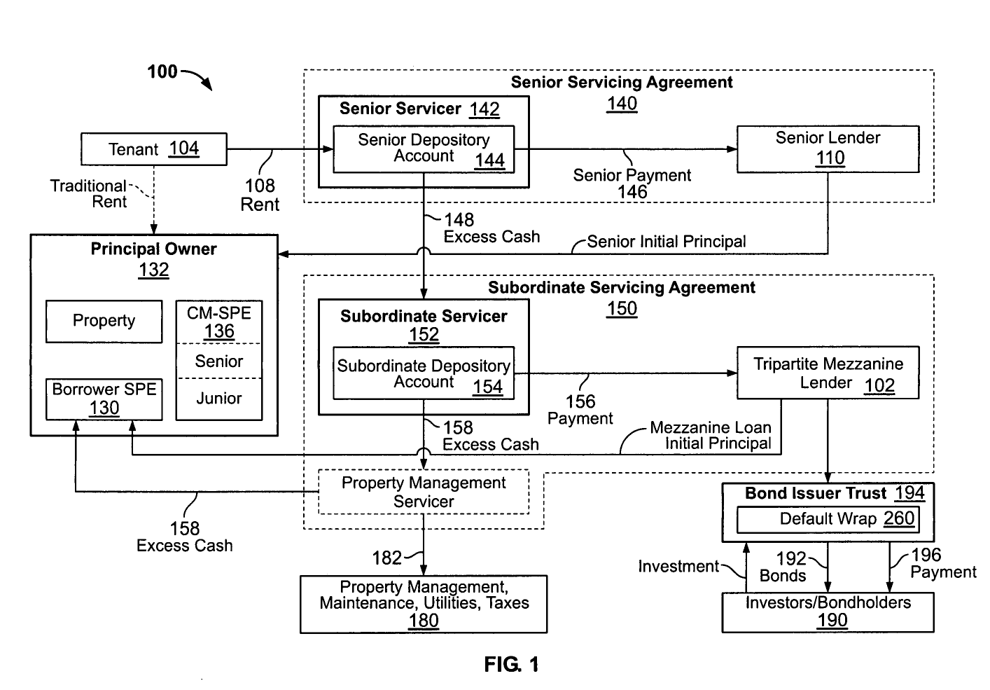

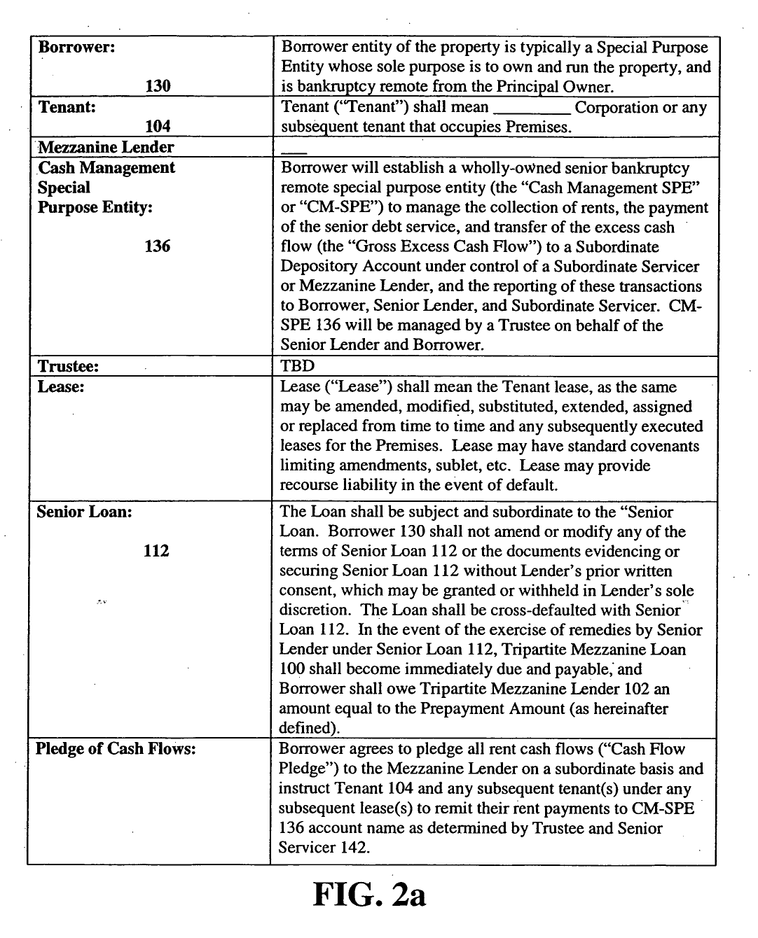

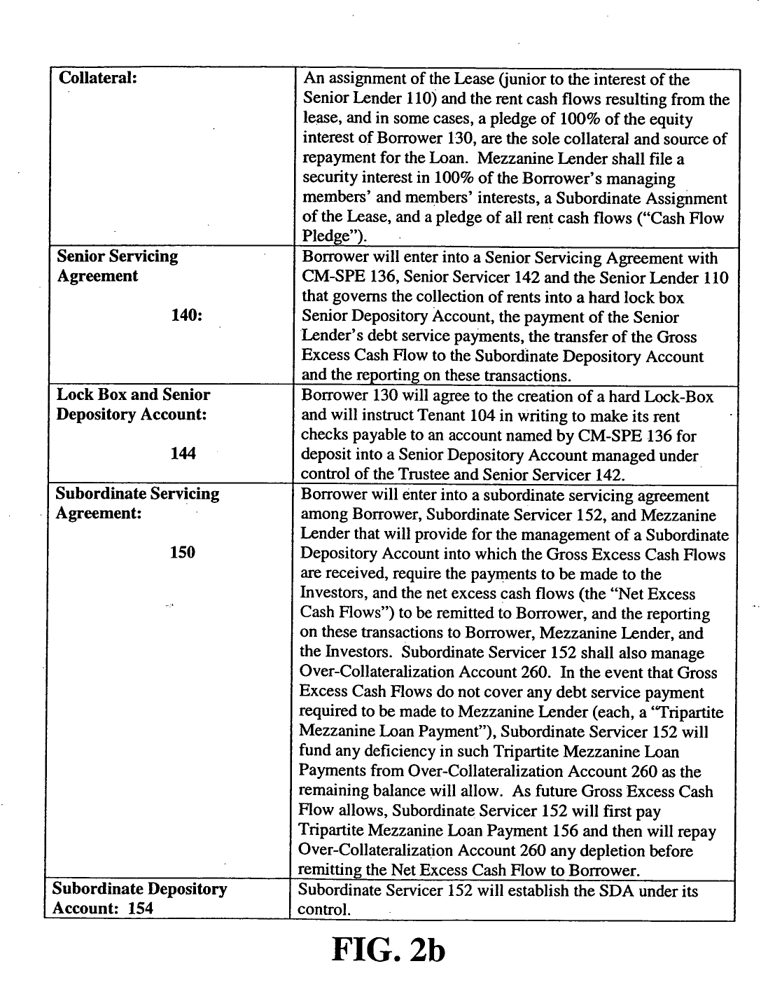

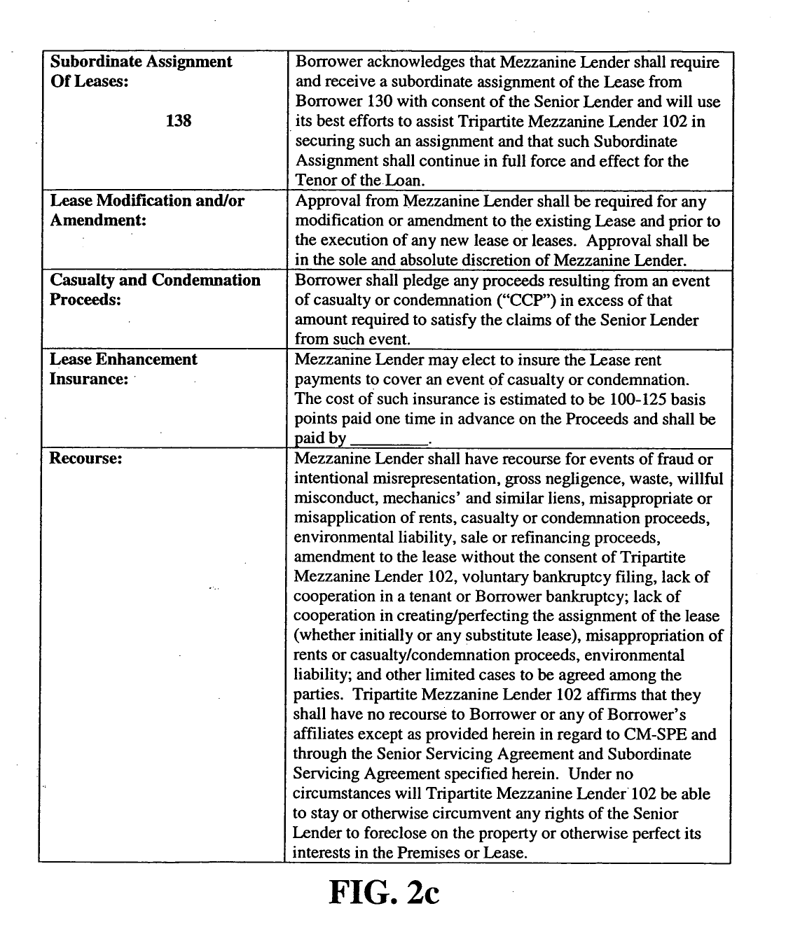

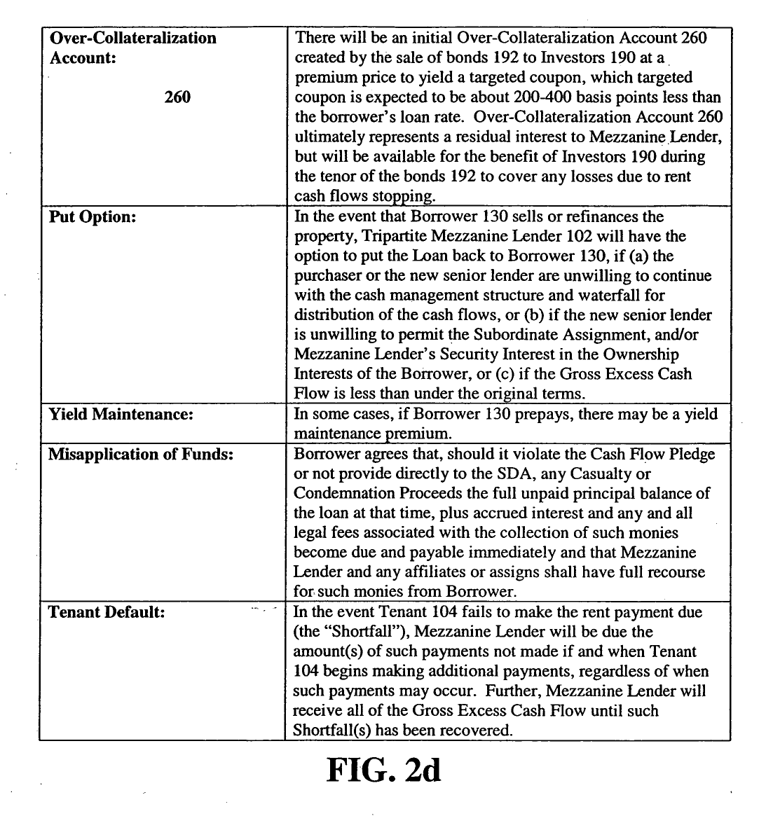

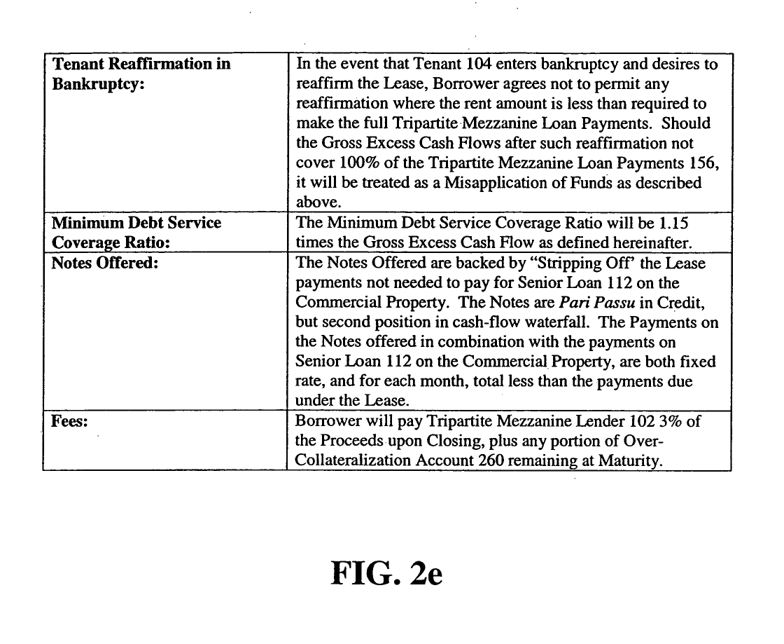

Referring to FIGS. 1 and 2, Tripartite Mezzanine Loan 100 structure may be entered by Borrower 130, Tenant 104, a cash management special purpose entity (CM-SPE) 136, Senior Lender 110, Tripartite Mezzanine Lender 102, and one or more servicers 142, 152. Ownership of the property may be lodged in Borrower 130, a special purpose entity that may be created for the sole purpose of owning and managing the property, bankruptcy remote from Principal Owner 132, which in turn, is typically a partnership or other entity that has beneficial ownership of the real estate. Borrower 130 receives the proceeds of the Loan 100, and CM-SPE 136 assumes the repayment obligation on both Senior Loan 112 and the junior Tripartite Mezzanine Loan 100. Borrower 130 and Principal Owner 132 may irrevocably assign to CM-SPE 136 all right to payment of rent from Tenant 104. CM-SPE 136 (with the assistance of servicer 142, 152) maintains one or more Depository Accounts 144, 154, and agrees to pay Senior Lender 110 first, then Tripartite Mezzanine Lender 102, in some alternatives, all operating expenses, and then—only out of the residual—Borrower 130. The payments flow through the structure in a waterfall of priorities, with each party being paid in order of its priority claim, and the cash flows are isolated from any other interested party except to the extent each party is entitled. The position of Tripartite Mezzanine Lender 102 may be secured by either an assignment 138 of all rents from the leases (typically junior to a first assignment to Senior Lender 110), or by a “soft second” pledge of equity interests

The Tripartite Mezzanine Loan structure provides sufficient benefit to all parties that the objections to traditional mezzanine loans may be overcome. Because Tripartite Mezzanine Lender 102 has a payment priority senior to that of Borrower 130 and Principal Owner 132, Tripartite Mezzanine Lender 102 has a sufficient collateral position and limited risk. If the Tripartite Mezzanine Lender's concerns are addressed in this matter, a senior lender's objection to a mezzanine loan may be resolved, and all necessary parties may find it in their interests to enter the Tripartite Mezzanine Loan agreement. CM-SPE 136 and servicers 142, 152 may assume duties to intermediate between potentially-conflicting parties, Senior Lender 110 and Tripartite Mezzanine Lender 102.

In many alternatives, the Tripartite Mezzanine Loan structure isolates risk to the credit of Tenant 104, and isolates risk relating to the credit of Borrower 130, Principal Owner 132, or of CM-SPE 136, the property's value, the property type, geographic area, market conditions, and other elements of real estate risk As real estate cash flow risks are more isolated to the credit of Tenant 104, and Tripartite Mezzanine Lender 102 gains payment priority relative to the typical subordinate lender, the pricing or interest rate for Tripartite Mezzanine Loan 100 may more closely reflect the credit of Tenant 104, rather than of Borrower 130 or Principal Owner 132. This pricing or interest rate may be better than the typical subordinate loan to a commercial lessor.

II. Tripartite Mezzanine Loan Structure

II.A. Legal Structure

In order to qualify a potential borrower, Tripartite Mezzanine Lender 102 may prefer to offer to lend against leases of investment grade single tenant properties, or to multi-tenant properties, when Tenant(s) 104 is/are of investment grade or have sufficient credit quality in a larger, multi-tenant property that any bonds issued backed by Tripartite Mezzanine Lender 100 can be tranched and structured to investment-grade blended levels.

The lease underlying a Tripartite Mezzanine Loan 100 may typically be a double or triple net lease, that typically lets an entire property to a single investment grade tenant of commercial property, for example, office, warehouse or retail facilities. (In a “triple net lease,” the tenant is responsible for all real estate expenses, including taxes, maintenance, etc. except casualty and condemnation. A “double net” lease is similar, except that the lessor is responsible for certain specified expenses, subject to a cap, and the tenant is responsible for expenses above the cap.) Such lease terms shift operating expenses, taxes, insurance costs and risks associated with owning and operating the property to Tenant 104, so that Borrower 130 and Principal Owner 132 have little or no responsibility to pay any operating expenses. In other alternatives, the structure may create reserves against these costs (see, e.g., § III.H). In either event, these costs are reserved for in the cash flow waterfall before paying Tripartite Mezzanine Lender 102 and Investors 190.

Referring again to FIGS. 1 and 2, Tripartite Mezzanine structure 100 may use two tripartite agreements 140, 150 that are linked by two Depository Accounts 144, 154 controlled by independent servicers 142, 152. The parties to Senior Agreement 140 may include Borrower 130 and/or Principal Owner 132, Senior Lender 110 and a Senior Servicer 142. Senior Agreement 140 may call for rents 108 to be paid into Senior Depository Account 144, from which Senior Servicer 142 pays (payment 146) Senior Lender 110 and passes the remaining cash flow 148 into the Subordinate Tripartite Servicing Agreement 150. Subordinate Servicing Agreement 150 among Borrower 130, Subordinate Servicer 152, and Tripartite Mezzanine Lender 102 calls for Subordinate Servicer 152 to pay Tripartite Mezzanine Loan payment 156 to Tripartite Mezzanine Lender 102 (or to Investors 190 designated by Tripartite Mezzanine Lender 102) and to remit the net excess cash flows 158 to Borrower 130 or Principal Owner 132. These two Tripartite Servicing Agreements 140, 150 are linked by an obligation of Senior Servicer 142, pursuant to Tripartite Mezzanine Loan Agreements 140, 150, to remit 100% of the gross excess cash flows 148 directly from Senior Depository Account 144 to the Subordinate Depository Account 154. Tripartite Mezzanine Loan 100 may be financed by Investors 190 based on the corporate bond rate of Tenant 104 (rather than the credit of Borrower 130 or Principal Owner 132), for example, with a spread to Tripartite Mezzanine Lender 102.

Borrower 130 is typically a partnership, limited liability partnership, limited liability company, grantor trust, or other form of a special purpose entity, chartered solely to own and lease the property, bankruptcy remote from Principal Owner 132, with independent directors. In some alternatives, Tripartite Mezzanine Lender 102 may require approval of the charter or partnership documents for Borrower 130, for example, to limit Borrower 130 from incurring additional debt, and may require proof of adequate capitalization of Borrower 130 by Principal Owner 132. Independent of the Tripartite Mezzanine structure, many commercial properties are typically owned by such special purpose entities, and the existing charter of that entity may in many cases satisfy the requirements of Tripartite Mezzanine Lender 102 with little further charter modification.

Cash Management Special Purpose Entity (CM-SPE) 136 may be specially created to own the lease for the life of Tripartite Mezzanine Loan 100. CM-SPE 136 may assume obligations to collect rent 108 from Tenant 104, pay the senior debt payment 146, transfer the gross excess cash flow 148 to Subordinate Depository Account 154, and report on these collection and payment efforts to Borrower 130 and Senior Lender 110. However, none of these activities of CM-SPE 136 affect the property itself, because title to the property and all rights relating to the property may remain with Borrower 130. CM-SPE 136 may be 100% owned by Borrower 130 and/or Principal Owner 132, and bankruptcy remote from Borrower 130 and Principal Owner 132. A trustee may be appointed for CM-SPE 136 that is mutually acceptable to Senior Lender 110 and Tripartite Mezzanine Lender 102. CM-SPE 136 may be chartered to exist for the life of Tripartite Mezzanine Loan 100 or for the longer of the two debt tenors.

Borrower 130 may covenant, represent or warrant to Tripartite Mezzanine Lender 102 that it will cause all leases currently in effect or that are made in the future to be conveyed and pledged to the CM-SPE 136 and/or to Tripartite Mezzanine Lender 102 along with a subordinate assignment 138 of the leases and that it will instruct in writing all current and future tenants to make their rent payments directly to Senior Depository Account 144.

Senior Servicing Agreement 140, among Borrower 130, CM-SPE 136, Senior Lender 110 and Senior Servicer 142, may require Senior Servicer 142 to collect rents 108, disburse payments 146 on Senior Loan 112 as due to Senior Lender 110, transfer the gross excess cash flows 148 to Subordinate Depository Account 154, and report on these collections and disbursements to the parties to Senior Servicing Agreement 140. Senior Servicing Agreement 140 may also create a hard lock-box arrangement and Senior Depository Account 144.

Subordinate Servicing Agreement 150 may create a Subordinate Depository Account 154 into which all gross excess cash flows 148 after payment 146 of Senior Loan 112 (and, in some alternatives, any operating expenses not the responsibility of Tenant 104) are transferred and deposited. Borrower 130 may irrevocably direct CM-SPE 136 and the Senior Servicer 142 to cause all such transfers of the gross excess cash flow 148 to Subordinate Depository Account 154. Subordinate Depository Account 154 may be maintained in the name of Subordinate Servicer 152 or Tripartite Mezzanine Lender 102. Tripartite Mezzanine Lender 102 may have a perfected security interest in Subordinate Depository Account 154. Subordinate Servicer 152 then disburses payments 156 to Tripartite Mezzanine Lender 102. Subordinate Servicer 152 then remits any net excess cash flows 158 to Borrower 130. Any misallocation of rents by Borrower 130, Principal Owner 132 or CM-SPE 136 may give Tripartite Mezzanine Lender 102 and its beneficiaries and affiliates full recourse to Borrower 130 and Principal Owner 132 for the unpaid principal balance of Tripartite Mezzanine Loan 100.

For any operating expenses that are not required to be paid by Tenant 104, Tripartite Mezzanine Loan servicing agreements 140, 150 may implement an irrevocable cash flow payment waterfall whereby all operating expenses are paid by servicers 142, 152 prior to Borrower 130 or Principal Owner 132 receiving any cash flow. Such operating expenses may be paid out of cash flows 148 before payment 156 to Tripartite Mezzanine Lender 102, or may be paid out of cash flows 158 after payment 156 of Tripartite Mezzanine Lender 102.

The entities and relationships described above are only one example among many possible alternatives. For example, because the contractual obligations of CM-SPE 136 and servicers 142, 152 to Senior Lender 110, to Tripartite Mezzanine Lender 102 and to Borrower 130 are clear, a single entity may perform two, or all three roles. In some alternatives, in view of the conflicts that may arise in the event of default by Tenant 104, it may be desirable to allocate the tasks of paying the two Lenders 110, 102 to two different servicers 142, 152 in priority order, as described above. In other alternatives, it may be desirable to combine these two functions in a single servicer, or to combine Senior Depository Account 144 and Subordinate Depository Account 154 into a single account from which payments 146, 156 and 158 are made. In other alternatives, it may be desirable to split the functions of CM-SPE 136 among two entities, one for each half of the overall structure. Servicers 142, 148 may be the same entity or two different entities, and may be a bank or similar trust organization. Tripartite Mezzanine Lender 102 may require that CM-SPE 136 be a single asset, bankruptcy-remote entity with no creditors other than Senior Lender 110.

The parties may agree that the property will be managed by a mutually-agreed property manager 180, with the approval of Tripartite Mezzanine Lender 102 over fees, terms and scope of services. In some alternatives, property management fees and expenses may be subordinated to Tripartite Mezzanine Loan 100. In other alternatives, Tripartite Mezzanine Loan 100 may be subordinate to these fees and expenses.

In some alternatives, Senior Lender 110 may approve a subordinate assignment 138 of the lease and of the lease rent cash flows 108 to CM-SPE 136 or to Tripartite Mezzanine Lender 102. In such cases, Tenant(s) 104 will be concurrently irrevocably directed to make rent payments 108 directly to the Senior Depository Account 144.

In other alternatives, Tripartite Mezzanine Lender 102 may look to Borrower 130 or Principal Owner 132, to repay the remaining principal balance in the event of a default by Tenant 104.

In other alternatives, Tripartite Mezzanine Lender 102 may take a “soft second” mortgage, a mortgage collateralized by a pledge of equity interests of Borrower 130 or Principal Owner 132, but without any lien directly against the real estate. Under a “soft second,” foreclosure on the “soft second” results in Tripartite Mezzanine Lender 102 acquiring ownership of Borrower 130 or Principal Owner 132, and thus the property itself, but subject to curing any default to Senior Lender 110. Tripartite Mezzanine Lender 102 may then re-market the property, or else liquidate the property entirely.

The Tripartite Mezzanine Loan agreements, including Senior Servicing Agreement 140, and Subordinate Servicing Agreement 150, may be entered contemporaneously with the origination of Senior Loan 112, or contemporaneously with the entry of the lease between Borrower 130 and Tenant 104, or may be entered later, underneath a pre-existing senior financing. Tripartite Mezzanine Lender 102 may require the usual documentation for a commercial real estate loan, for example, a description of the property, the purchase price, details of the Senior Loan financing 112 (including the tenors and identity of Senior Lender 110), documentation evidencing that Borrower 130 owns and controls the property, a copy of the lease between Borrower 130 and Tenant 104, appraisals, evidence of compliance with laws and regulations applicable to the property (including, for example, permits, approvals, licensing and zoning), title commitments, surveys, lien searches, property and liability insurance, environmental reports, physical condition reports, credit reports, background check on Principal Owner 132 and Borrower 130, and organizational documentation.

The loan may be underwritten based on the senior unsecured credit of Tenant(s) 104 and the underlying SWAPS benchmark rate for the tenor of the loan, which in turn may be based on the lease tenor. A spread may be added to the coupon appropriate to the senior unsecured borrowing rate of Tenant 104 to make the coupon attractive to buyers of the resulting Tripartite Mezzanine Loan, plus a premium for prepayment and an additional spread to serve as an incentive for an investment bank to fund the loan.

The loan documents may include conditions precedent, affirmative and negative covenants, representations and warranties, and miscellaneous provisions typical to commercial real estate and/or credit tenant financing structures, or tranched bond structures.

II.B. Interest-Only Variant

In some cases, Tripartite Mezzanine Loan 100 may be structured as a fully self-amortizing level-payment loan.

In other cases, Tripartite Mezzanine Loan 100 may be structured as an interest-only loan for an initial portion of the term, and the remaining term of the loan may use self-amortizing payments. For example, a ten-year loan may have an interest-only first year, under which the lease payments may flow through Servicers 142, 152, and payment 156 to Tripartite Mezzanine Lender 102 may be limited to interest only, without an amortization of principal. At the end of the year, Borrower 130 may have an option to pay the entire principal (this principal will be equal to the initial principal of the loan). If Borrower 130 does not exercise this option, then the loan may automatically roll into a self-amortizing nine-year extension term. The payments during this nine-year extension term will, of course, be somewhat higher than the equivalent payments would be under a full ten-year self-amortizing arrangement. Consequently, so that the debt service load during the nine-year extension term does not exceed the underwriting limit that Lender 102 applies to Tenant 104 and the underlying lease, the maximum amount to be lent on these terms will be somewhat lower.

An interest-only arrangement provides a much lower debt service ratio for Owner 132 during the first year. This may be especially attractive in cases where Owner 132 intends to sell the property during that year.

Other payment structures may be agreed by the parties.

II.C. Bonding, Syndicating, or Securitizing the Loan to Investors

Tripartite Mezzanine Loans may be sold on a whole loan basis fairly readily, because the expected loss rate on a Tripartite Mezzanine Loan 100 may be lower than that of a corporate bond, as discussed in § VI.D.

Alternatively, the loan documents may give Tripartite Mezzanine Lender 102 the right to assign, syndicate, sell, pledge, securitize, or participate all or any portion of a Tripartite Mezzanine Loan to Investors 190. Borrower 130 may agree to cooperate in any such arrangement. An Issuer Trust 194 may be created by Tripartite Mezzanine Lender 102, Borrower 130, Principal Owner 132 or CM-SPE 136, to issue bonds 192, make bond payments 196, and make accounting and reports on the payments and balances. Issuer Trust 194 may be chartered to exist for the longer of the two debt tenors.

The tenors of Tripartite Mezzanine Bonds 192 may extend for any desired amount of time, to a maximum tenor coterminous with the lease. Ten years may be a typical tenor. The rate may be about 500 basis points above the senior unsecured borrowing rate of Tenant 104.

The pricing of bonds 192 may be based on the senior unsecured borrowing spread of Tenant 104 plus a spread to provide an illiquidity premium to cover minor cashflow inconsistencies.

Tripartite Mezzanine Bonds 192 may be issued as asset-backed securitization or collateralized loan obligations. The “asset” that technically serves as the bond collateral is a junior assignment 138 of the leases, a pledge of the equity interests of Owner 132.

A Tripartite Mezzanine Loan 100 may either be sold in whole loan form to Investors 190 or may be financed through a bond issue 192. The debt from the issuance of bonds 192 may be carried on the balance sheet of CM-SPE 136, Tripartite Mezzanine Lender 104, or Issuer Trust 194.

II.D. Mating Mezzanine Financing to Senior Financing

Tripartite Mezzanine Loans 100 may be suited to the acquisition of assets, refinancing of assets, or taking out equity by layering mezzanine debt on assets that retain the existing senior debt 112.

In the event that Borrower 130 elects a public bond issue for senior financing 112 (for example, in a commercial mortgage-backed securities issue), it may be desirable to use a “hard” or “soft” lockbox structure for the payments, to ensure Tripartite Mezzanine Lender 102 and Investors 190 that Borrower 130 does not have the ability to divert rent cash flows away from the payment priority agreed to in the bond covenants and upon which they had based their investment decisions and financial evaluations. In contrast, where senior financing 112 is a private placement to a single lender (such as a life insurance company), lockbox arrangements are less common, because of the greater flexibility Senior Lender 110 has to exploit its avenues of recourse. Tripartite Mezzanine Loan structure 100 can be used with either form of senior financing 112.

III. Further Reducing Risk to Investors

Even though the Tripartite Mezzanine Loan structure inherently reduces default frequency and loss severity (see § VI.D), there may still be some risk of default by Tenant 104 and consequent loss.

The default risk of a Tripartite Mezzanine Loan 100 may be hedged or insured through one or more of several alternative arrangements, even in alternatives where Tripartite Mezzanine Loan 100 is made with no collateral from the property or ownership interest. Especially in alternatives where Tripartite Mezzanine Loan 100 is isolated from the property, and collateralized solely by the creditworthiness of Tenant 104, credit derivatives may be used to hedge out much or all of the default risk. These features may give Tripartite Mezzanine Bonds 192 cash flow ratings comparable to those of a bond type lease.

III.A. Hedging Strategies

Financial derivatives may be used to hedge out any perceived residual loss risk during the aggregation and securitization period, particularly where Tenant 104 is an investment grade company, or where Tenant 104 has issued either bonds or publicly traded stock.

In some cases, CM-SPE 136 may purchase a credit default swap from a swap dealer to cover defaults. A credit default swap is a contract that historically involved a swap of one type of risk for another, but has evolved into a custom contract to simply buy protection, much like insurance, against default. A typical credit default swap contract provides that if Tenant 104 defaults on the lease, CM-SPE 136 provides notice to the swap dealer, and the swap dealer pays the balance of the principal and interest due on the loan. Such swaps are available, for example, from Deutsche Bank. The swap dealer may short bonds or stock to be able to deliver the contracted-for coverage in the event Tenant 104 defaults, and the dealer will manage risks internally to ensure that these shorts are neither overhedged nor underhedged.

In other cases, a Tripartite Mezzanine Loan 100 may be hedged, for example, as follows. Consider an example Loan 100 collateralized by a lease with nine years' remaining tenor. The risk to the principal may be hedged by buying put options on debt or equity securities of Tenant 104, one put corresponding to each year remaining in the tenor of the Loan 100. Each put option allows Tripartite Mezzanine Lender 102 to tender securities to a counterparty, and demand payment at an agreed exercise price, even if the current market price of the securities is above the agreed exercise price.

Each put covers securities that, at the exercise price of the put, have a value equal to the principal that is to be retired in the corresponding year. Should Tenant 104 default on the underlying lease, the tenant's stock or bonds would drop in value significantly. For example, if Tenant 104 goes bankrupt in year 3 of a ten-year lease, then the put options expiring at the end of years 3, 4, 5, 6, 7, 8, 9 and 10 will together cover the remaining principal balance. This gain may offset any losses from default by Tenant 104. If Tenant 104 reaffirms or Borrower 130 re-lets the space successfully (see § VI.D, below), the hedge may simply earn additional income for Tripartite Mezzanine Lender 102. The cost of the hedge may be paid for out of the excess spread earned from the Loan 100.

Similar arrangements may be synthesized using short sales of equity or debt of Tenant 104, one short position for each time period remaining in the loan tenor. The shorts allow Tripartite Mezzanine Lender 102 to purchase the stock or bonds cheaply and deliver them at the higher strike price of the short. If Tenant 104 company defaults on the lease, Tenant 104 may also likely declare bankruptcy. CM-SPE 136 may then liquidate the short position at a price of essentially zero, allowing CM-SPE 136 to retain the price of the short, and cover the default.

In other cases, the default risk may be covered by an insurance wrap, or other financial derivative.

In alternatives where the default risk is entirely hedged, the risk of Tripartite Mezzanine Lender 102 and Investors 190 may be completely defeased, even though Tripartite Mezzanine Lender 102 has no recourse to the property, to Tenant 104 or to Borrower 130.

III.B. Over-Collateralization Account

Referring to FIG. 2d, Tripartite Mezzanine Loans 100 may be wrapped in Over-Collateralization Account 260, set aside out of the excess spread above the blended senior unsecured borrowing rate of Tenant 104, or by a premium at issue, to provide a significant recovery for Tripartite Mezzanine Lender 102 or Investors 190 in the event of a default. Over-Collateralization Account 260 may be sized to provide six to eight months of payments to Investors 190, depending on the local market conditions, to provide for the timely payment of bond payments 196 during the time it takes for Borrower 130 to re-let the vacant space. Therefore, as long as Borrower 130 re-lets the space within this time, and Senior Lender 110 does not exercise remedies that impact re-letting, Over-Collateralization Account 260 may ensure that there is no default in the bond payments 196. If Borrower 130 does not re-let the space in that period, there may be a cessation of payments 196 for some period, but ultimately payments may resume upon successful marketing of the vacant space, provided Senior Lender 110 does not have and exercise remedies during such period. Similarly, in the event that Tenant 104 defaults and enters bankruptcy, and Borrower 130 chooses not to pay Senior Loan 112, and Senior Lender 110 forecloses, this same Over-Collateralization Account 260 may be paid to the Investors 190.

Over-Collateralization Account 260 may be targeted at 5-15% or more preferably, 7.5-10%, of the initial principal balance. In alternatives where Tripartite Mezzanine Loan 100 is fully amortizing, this Over-Collateralization Account 260 grows relative to the principal loan balance over the tenor of the Loan 100 and may reach the average corporate bond recovery as a percent of remaining principal balance after 75% of the tenor has been reached. Depending on the degree to which bonds 192 have been repaid when such a default might occur, Over-Collateralization Account 260 may cover a significant portion or even all of the remaining principal balance.

In some alternatives, a separate Over-Collateralization Account 260 may be established to back each individual Tripartite Mezzanine Loan 100 on a bankruptcy-remote basis from every other Loan 100 and its Over-Collateralization Account. In other alternatives, several Over-Collateralization Accounts 260 for several distinct Tripartite Mezzanine Loans 100 may be pooled or cross-collateralized. For Investors 190 participating in a pool of Tripartite Mezzanine Loans 100, the expected default and recovery rates for such a pool, equal that of typical corporate bonds as early as 20% of the blended tenor of the pooled Loans 100.

Use of an Over-Collateralization Account 260 may be most desirable in a securitized structure, such as a collateralized loan obligation. If Tripartite Mezzanine Loans 100 are sold in whole loan form without an Over-Collateralization Account 260, rather than pooled or securitized, the buyer may receive an additional excess spread to compensate for increased risk of loss.

III.C. Borrower's Liability Survives Default or Bankruptcy of Tenant

The loan documents 140, 150 may provide that in the event that Tenant 104 defaults on any rent payment, then unpaid debt service 156 on the Loan 100 may accrue, with interest, due to Lender 102 if and when Tenant 104 (or any replacement tenant) begins making rent payments 108, regardless of when such payments may be made and regardless of any other remedies Tripartite Mezzanine Lender 102 may have exercised. Further, until any shortfall has been recovered, the loan documents may provide that Tripartite Mezzanine Lender 102 will receive 100% of the net cash flow and/or residual proceeds from the sale or refinancing of the property (subordinate to payment of any amounts due out of such proceeds towards Senior Loan 112).

The loan documents 140, 150 may provide that in the event that Tenant 104 enters bankruptcy, Borrower 130 shall not take any action in connection with the bankruptcy without the prior consent of Tripartite Mezzanine Lender 102. Tripartite Mezzanine Lender 102 may be given the right, without obligation, to, vote, file and prosecute any and all claims of Borrower 130 in any bankruptcy of Tenant 104. The loan documents 140, 150 may obligate Borrower 130 to object to and use its best efforts to prevent any assumption and assignment of the lease to any future tenant with a lower credit rating than that of the original Tenant 104 as of the closing date of the Loan 100.

III.D. Obligations of Tenant on Reaffirmation of Lease in Bankruptcy

In some alternatives, if Tenant 104 enters bankruptcy, and Tenant 104 desires to reaffirm the lease, Tenant 104 may be required to pay of either one year's rent or 15% of the remaining principal balance of the rent for up to three years. In another alternative, Tenant 104 may covenant to pay the rent reserved by the lease, without acceleration, for the greater of one year, or 15%, not to exceed three years, of the remaining tenor of the lease. Since Senior Lender 110 has the senior lien on the lease and may or may not choose to pursue this recovery, it may be difficult to predict what recovery may be available to Tripartite Mezzanine Lender 102 and Investors 190. These covenants may be framed as obligations of Borrower 130 to negotiate such prepayments by Tenant 104 as part of reaffirmation of the lease in bankruptcy.

III.E. Condemnation or Casualty

III.E.1. Condemnation

The government may take private property for public use through condemnation or eminent domain proceedings by paying compensation to the property owners.

Most triple-net or double-net leases obligate Tenant 104 to continue to make payments under the lease in case of a temporary or partial taking that permits the continued use of the property. However, in the case of a total taking or a partial taking, that renders the remaining portion of the property unsuitable for its intended use, the lease typically will terminate, and Tenant 104 may be obligated to pay an amount sufficient to retire the outstanding debt.

If the government takes a portion of the property, that does not render the remaining portion unsuitable for Tenant 104 to terminate the lease, Borrower 130 may be required to apply the condemnation award proceeds to partially prepay the debt and thereafter reduce the lease payments due to an amount sufficient to pay all the future debt service. To the extent Tenant 104 is not obligated under the lease to follow the above procedure, Borrower 130 may provide for insurance to cover the condemnation risk.

III.E.2. Casualty

Borrower 130 and/or Tenant 104 may be required to carry casualty insurance, and, in the case of damage or destruction, to apply all insurance proceeds to repairing or rebuilding the property as nearly as practicable to its previous fair market value and utility.

As part of the underlying lease, Tenant 104 may have assumed an obligation that, where the insurance proceeds are insufficient to restore the property, Tenant 104 must complete the restoration at its own expense. If restoration is economically impractical following a substantial casualty, often Tenant 104 may terminate the lease by paying a termination amount or by purchasing the property in an amount at least sufficient to retire the outstanding debt. To the extent Tenant 104 is not obligated for the above, the Borrower 130 may provide insurance to mitigate the casualty risk.

Borrower 130 may irrevocably direct Senior Lender 110 to pay all excess casualty insurance proceeds and condemnation awards above the amount necessary to satisfy the claims of the Senior Lender from such event into the Senior Depository Account 144, for transfer to Subordinate Depository Account 154.

III.E.3. Lease Enhancement Insurance

In some alternatives, if there is some risk that Tenant 104 may terminate the lease or abate or reduce rental payments as a result of any casualty or condemnation, then Borrower 130 may be required to provide a non-cancelable, fully prepaid lease enhancement or lease interruption insurance policy naming Tripartite Mezzanine Lender 102 as insured, in an amount sufficient to pay the outstanding principal amount of Tripartite Mezzanine Loan 100 together with any accrued interest. This insurance, available from AIG, may cost approximately 75-100 basis points as a one-time fee payable upon execution of Tripartite Mezzanine Loan 100.

III.F. Full Recourse Due and Payable in Some Events

Tripartite Mezzanine Loan 100 may become full recourse to Borrower 130 and Principal Owner 132 in the event of certain “bad boy acts” or force majeur external events. “Bad boy acts” or “bad boy events” is an established term of art, varying slightly from transaction to transaction, generally relating to bad faith actions of the tenant, including misdirection of rent payments, erosion or destruction of collateral, requiring additional investment by the lender, or improper use of bankruptcy. Examples of “bad boy acts” may include any transfer or encumbrance of the property or any interest therein in violation of the loan documents, any change to the lease without the prior written consent of Tripartite Mezzanine Lender 102, a voluntary bankruptcy filing by Borrower 130, or in the event Principal Owner 132 or any officer, member, principal, representative or affiliate of Borrower 130 files, solicits or joins in the filing of an involuntary petition against Borrower 130, lack of cooperation by Borrower 130 or Principal Owner 132, or any officer, member, principal, representative or affiliate of Borrower 130 in a bankruptcy of Tenant 104 or Borrower 130, lack of cooperation in creating or perfecting the subordinate assignment 138 of the lease (whether initially or with respect to any replacement lease), any default under Senior Loan that is not caused by an act or omission of Tenant 104, any termination of the lease by Tenant 104 except as a result of a casualty or condemnation, any default with respect to the special purpose entity covenants, or default with respect to the reporting requirements in the loan documents. External force majeur events may include environmental issues or new legislation that alters the bargain.

In certain events, Tripartite Mezzanine Lender may have the right to require Borrower 130 to prepay the Loan 100 in full by paying the outstanding principal balance plus all accrued interest and all other sums due under the loan documents, and possibly a prepayment consideration. These events may include any one or more of the following, unless approved by Tripartite Mezzanine Lender 102: (a) any reduction in the rents payable by Tenant 104, (b) any refinancing, replacement, modification or restructuring of Senior Loan 112 resulting in an increase in the monthly payments due under Senior Loan 112, or resulting in Senior Lender 110 or any new holder of Senior Loan 112 being unwilling to maintain the rights of Tripartite Mezzanine Lender 102, (c) any exercise by Senior Lender 110 of any rights or remedies under the Senior Loan documents, (d) if the lease terminates or for any reason Tenant 104 is no longer fully obligated under the lease, unless the lease is replaced with another satisfactory to Tripartite Mezzanine Lender 102, (e) if Borrower 130 no longer owns fee title to the property, or (f) the occurrence of an uncured event of default under the Loan Documents.

The terms of a Tripartite Mezzanine Loan 100 may limit the right of Borrower 130 to prepay the Loan 100, or may provide that any prepayment would include a yield maintenance premium.

III.G. Limitation on Borrower Incurring Debt or Disposing of the Property

Loan documents 140, 150 may provide that any transfer of the property or of any ownership interest in Borrower 130 or Principal Owner 132 shall require the prior written consent of Tripartite Mezzanine Lender 102. In some alternatives, Tripartite Mezzanine Lender 102 may be given absolute discretion to approve any transfer that would result in (a) a change in control of Borrower 130, (b) Borrower 130 or any single purpose entity holding equity in Borrower 130 ceasing to be a single purpose entity, or (c) a dissolution or termination of Borrower 130. Any such transfer may be subject to a fee payable to Tripartite Mezzanine Lender 102.

Loan documents 140, 150 may limit the ability of Borrower 130 or Principal Owner 132 to assume additional debt beyond Senior Loan 112 or ordinary trade payables, for example, by setting a minimum debt service coverage ratio, or a maximum level of trade payables.

III.H. Required Reserves

In some alternatives, especially where Borrower 130 is obligated under the lease to repair or maintain the property, and/or to pay taxes, insurance or any other monetary obligation, or where there may be some other risk exposure, Tripartite Mezzanine Lender 102 may require Borrower 130 to fund reserve accounts to cover these expenses. These reserves may be waived if reserves for the same purposes are maintained in connection with Senior Loan 112.

IV. Reaffirmation Database

It may be desirable to develop a database of leases, bankruptcies, reaffirmations of leases in bankruptcy, and rates of success in re-letting space where leases are not reaffirmed. Such statistical data on reaffirmation may substantially improve the ability of the ratings agencies and investors to accurately assess the default probability for Tripartite Mezzanine Loans 100. This information may enable better, higher ratings and therefore better execution through lower overall cost-of-funds.

This database may be gathered by examining bankruptcy filings over several prior years in the bankruptcy and district courts in the United States, focusing on investment grade companies, and determining whether the identified companies are still occupying the same offices and other premises. If companies have vacated the premises they had occupied prior to filing bankruptcy, a researcher may attempt to identify whether the vacating of the property was related to the bankruptcy or was in the ordinary course of business. Examples where the companies vacated certain premises may be classified by the type of property that was vacated (i.e., office, warehouse, manufacturing, distribution, etc.), the geographic location, the size of the company, and the credit rating of the company at the time of filing.

Such database may enable investors and rating agencies to assess probability of reaffirmation by type of industry, property use, size of company, credit grade, and geography. This may improve the underwriting process, the ratings of securitizations, and the ultimate pricing and yields investors receive. The database may allow for Lender 102 to take out more spread in the form of the residual interest or premium price obtained, or lower prices and yet still lend profitably. Better default frequency information may cause Investors 190 to value Loans 100 and Bonds 192 more highly.

V. Increased Opportunities for Structuring Financing

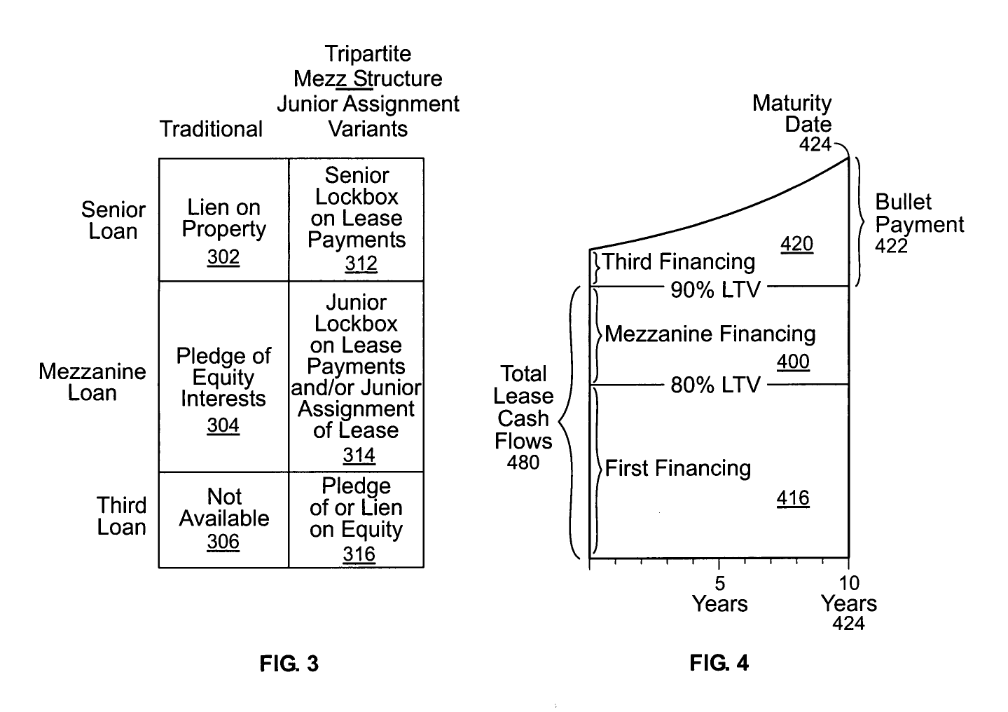

Referring to FIG. 3, in some cases, Senior Lender 110 takes a lien 302 on the property itself, and Tripartite Mezzanine Lender 102 takes a “soft second” pledge 304 of the shares of Owner 132, the partnership or special purpose entity that owns the property. In this arrangement, all interests of Borrower 130 and Principal Owner 132 have been encumbered, and there is no further collateral 306 available for a third loan.

In other cases, a Tripartite Mezzanine Loan structure may be structured so that the Senior Lender 110 and Tripartite Mezzanine Lender 102 take control 312, 314 of the lease payments, and leave the property itself and the partnership interests 316 unencumbered, available as collateral for third and fourth mortgages.

Referring to FIG. 4, Borrower 130 may obtain financing whose payments exceed the total amount supported by the lease cash flows. In FIG. 4, the total monthly payments 480 on Senior Loan 416 (with a lien on the property) and second financing (a Tripartite Mezzanine Loan) 400, and whatever incidental expenses are to be borne by Borrower 130 (such as taxes, maintenance, and utilities, to the degree these have not been contracted out to Tenant 104 under a double net or triple net lease) may equal the total 480 of the lease cash flows. Because the ownership interest remains unencumbered, Borrower 130 may borrow an additional third amount 420 on a zero-coupon note collateralized by the ownership interest, to be repaid in a bullet payment 422 of principal and accrued interest at the end 424 of the lease tenor. This may provide increased leverage for owners of commercial real estate.

Further, the Tripartite Mezzanine Loan structure may provide additional options and optimization of the capital structure for a real estate asset. The Senior Loan 416 may typically obtain a rating of the tenant's corporate bonds (or possibly better), suitable for a typical insurance company investment. The second financing 400, under a Tripartite Mezzanine Loan structure, may have a slightly higher yield and yet still be investment grade, suitable for the typical corporate bond investor. The third bullet financing 420 may carry a high yield appropriate for certain investors, for example, the typical junk bond investor. Thus, by balancing the amounts of the different tiers of financing, the Tripartite Mezzanine Loan structure may provide some combination of greater cash flows for Borrower 130, higher loan-to-value leverage, lower interest rate, or longer tenor for Borrower 130.

A Tripartite Mezzanine Loan structure may be used with a traditional mortgage, with commercial mortgage backed securities (CMBS) or credit tenant lease (CTL) senior debt forms.

VI. Investor Valuation of Tripartite Mezzanine Bonds

A Tripartite Mezzanine Loan 100 may have credit characteristic of a senior unsecured direct obligation of Tenant 104, that can only go into default if Tenant 104 defaults on its rent obligation by entering bankruptcy. Even though a Tripartite Mezzanine Bond 192 is subordinate to Senior Loan 112, it may have credit characteristics of a senior unsecured term debt obligation of Tenant 104 backed by the underlying space lease obligation, and should perform in a similar manner. That is, a Tripartite Mezzanine Loan 100 should go into default for the same reasons and under the same circumstances as any other senior unsecured debt of Tenant 104 in the corporate debt markets. As will be discussed in § VI.D, Tripartite Mezzanine Loan 100 may actually perform better than corporate debt counterparts.

VI.A. Loan Pricing Arbitrage

Traditional commercial mezzanine loans are priced (that is, interest rate and various fees) by the risk associated with property value leverage or loan-to-value (“LTV”) and their rates are sensitive to change in LTV. Regardless of the credit quality of Tenant 104, traditional mezzanine loan pricing increases fairly linearly with the increase in LTV. In contrast, the pricing of Tripartite Mezzanine Loan 100 is relatively independent of LTV leverage, and is related nearly solely to the credit quality of Tenant(s) 104. Thus the pricing may be based on the senior unsecured borrowing rate of Tenant(s) 104. As LTV increases, the credit quality of Tenant 104 is unaffected, and the pricing may remain nearly the same.

Therefore, Tripartite Mezzanine Loan 100 may have an increasing advantage as LTV leverage increases. As tenant credit quality increases, pricing of Tripartite Mezzanine Bonds 192 may decrease, decrease in staggered steps, or may remain fixed. Rates might be 10% for loans to A and BBB credit grade tenants and 9% for AAA and AA credit tenants. The spread between the loan rate and the bond coupon may be determined by the credit of a specific Tenant 104 and the tenor of the loans. If the average life of the Loan 100 or Bond 192 is 6 years, and the Swap rate for 6 years is 3.1%, and the tenant's unsecured borrowing rate spread is 175 basis points, then the base bond coupon would be 4.85%.

A further premium may be added to allow for prepayment, illiquidity, and subordination. The prepayment premium might be 75 basis points and depends on the credit quality of Tenant 104, the lockout period, and the tenor of Bonds 192. The illiquidity and subordination premiums may be fairly static. A portion of the premium allocated to illiquidity may compensate Investors 190 for the fact that this is a new asset class and investors may be expected to hold the Bonds 192 to maturity or until a secondary market in Tripartite Mezzanine Bonds 192 develops. The portion allocated to subordination may compensate the Investors 190 for their position of being subordinate to Senior Lender 110 in the event of a default. The combined premium may be about 100 basis points. Thus, in the example, the Tripartite Mezzanine Loan bond coupon might be expected to be about 6.6%. This would provide a spread of 340 basis points between the 10% loan rate and the bond coupon.

In 2003, commercial mezzanine loans are usually made at rates ranging from 12-13% for eighty-percent aggregate capitalization (80 LTV) to 20% or more for ninety-percent aggregate capitalization (90+LTV) and have repayment tenors of three to five years. In contrast, a Tripartite Mezzanine Loan 100 may carry a rate of (9%-12%) for investment grade tenants (possibly higher for lower grade tenants), and may extend for about ten years.

Unlike traditional mezzanine debt, the Tripartite Mezzanine structure may not require an inter-creditor agreement between Tripartite Mezzanine Lender 102 and Senior Lender 110. In many alternatives, the Tripartite Mezzanine structure does not require such an agreement because Tripartite Mezzanine Loans 100 give Tripartite Mezzanine Lender 102 no interest in the partnership, and do not create situations in which Tripartite Mezzanine Lender 102 can become the operator of the property, the obligor to Senior Lender 110, or otherwise acquire any interest in the property.

VI.B. Valuation of Bonds Issued by a Tripartite Mezzanine Structure

Tripartite Mezzanine Bonds 192 may compare favorably with corporate bonds issued by Tenant 104. Even though a Tripartite Mezzanine Bond 192 may have a lower frequency of default, greater recovery and lower loss severity than a corporate bond of Tenant 104, Tripartite Mezzanine Bonds 192 may provide higher yields to Investors 190.

Tripartite Mezzanine Bonds 192 may be underwritten based on the character of existing leases and the credit quality of Tenant 104. Real estate lease obligations are similar in many ways to corporate bonds and may be valued by bond valuation techniques that measure the certainty of the cash flows over the tenor of the lease. Like other lease collateralized loans, Tripartite Mezzanine Bonds 192 may be valued based on the existing leases, tenant quality and default risk, a risk premium over treasuries of a comparable corporate bond, severity, duration, and the excess lease cash flows after servicing 146, 156 the mortgage debt, avoiding speculation on the real estate's future value.

VI.C. Subordinate, But Really Pari-Passu

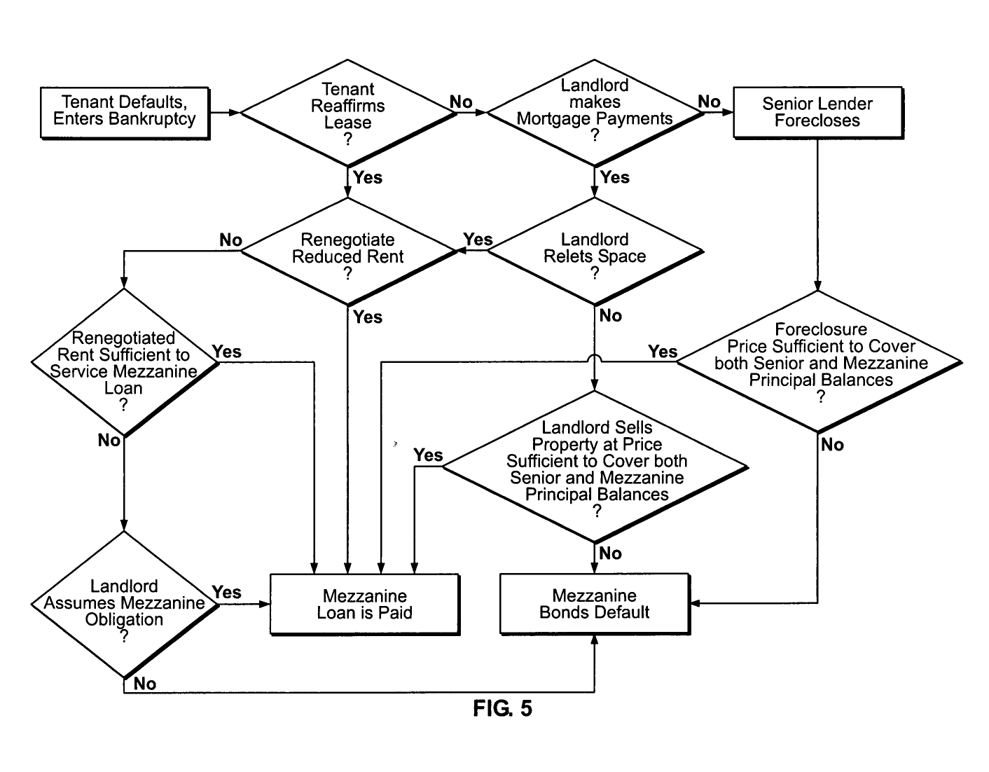

Referring to FIG. 5, in alternatives where a Tripartite Mezzanine Loan structure includes a subordinate assignment 138 of the lease rent and cash flows, the collateral is technically subordinate to the interest of Senior Lender 110. Similarly, Tripartite Mezzanine Loan payments are subordinate to Senior Loan 112. In the event of a default by Tenant 104 or Borrower 130, Tripartite Mezzanine Loan Bond payments 156, 196 are subordinate to Senior Lender 110 taking possession of the property and the rent cash flows. A default by Tenant 104 or Borrower 130 could result in a foreclosure on Senior Loan 112 or Senior Lender 110 otherwise taking possession of the property and all of the rent cash flows 108. All that Tripartite Mezzanine Lender 102 may receive in this scenario is the remaining principal balance and any Over-Collateralization Account 260.

However, as a practical matter, with a single tenant property, Tenant 104 either makes the entire lease rent payment or not at all. If Tenant 104 defaults, files for bankruptcy, and rejects the lease, Tenant 104 will not make the payment. In this event, Senior Lender 110, who has a senior claim on the lease payments, will receive little or no payment, and neither will Tripartite Mezzanine Lender 102. In nearly all other scenarios, Tenant 104 makes the payment, and both Senior Lender 110 and Tripartite Mezzanine Lender 102 receive their entire payments 146, 156. Thus, as a practical matter, Senior Lender 110 and Tripartite Mezzanine Lender 102 may be effectively pari-passu to one another with respect to the lease rent cash flows 108.

VI.D. Evaluating Credit Default Risk

The credit risk of a Tripartite Mezzanine Loan 100 is composed of the default probability and potential loss severity. As will be shown below, the probability of default on a Tripartite Mezzanine Loan 100 is:
Tripartite Mezzanine Loan Probability of Default=P*(1−R)*(1−L)
where
P=Probability Tenant Defaults on Lease Probability of default on corporate bonds
R=Probability Tenant Reaffirms Lease
L=Probability Lessor Re-lets Space in 8 months
   Industry surveys indicate that R, the probability that Tenant 104 reaffirms the lease in bankruptcy, is about 60%. Similarly, industry surveys indicate that L, the probability that Borrower 130 re-lets within 8 months (that is, within the coverage lifetime of Over-Collateralization Account 260, see § III.B), is about 75%. Together, these suggest that the default rate on Tripartite Mezzanine Bonds 192 may be about 10-40% the rate of default on the Tenant's corporate bonds.

The expected loss calculation is the following:
Expected Loss=(Probability of default)*(remaining principal balance)*(1−Recovery Rate)
It is estimated that the frequency of default of a Tripartite Mezzanine Loan 100 may be under 30% of the traditional corporate bond default rate. Loss severity on Tripartite Mezzanine Loan 100 may be greater than that for a corporate bond in the first several years and less than that for corporate bonds in the later years of the tenor. Recovery rates may be superior to that of corporate bonds of Tenant 104 for a variety of reasons discussed below in §§ VI.D.1 to VI.D.5. Together, these calculations show that expected loss severity of Tripartite Mezzanine Loans may be considerably better than that of corporate bonds.

VI.D.1. Reaffirmation of Leases in Event of Bankruptcy

When a corporation enters bankruptcy (step 502), the corporation will default on its corporate bonds and the bondholders join the bankruptcy as unsecured creditors. Most often, all of the corporation's leases go into technical or real default at the same time. At this point, the corporate bond and Tripartite Mezzanine Loan 100 would both be in default. However, the corporate bond will remain in default until the bankruptcy is fully resolved and the courts determine how much money is to be paid against the remaining principal balance, or until the corporation exits bankruptcy and begins to resume payments under a negotiated arrangement.

Investors 190 of Tripartite Mezzanine Bonds 192 may stand in better position than corporate bondholders.

First, the corporation in Chapter 11 bankruptcy may reaffirm (step 504) its lease for the space and then resume its lease payments without interruption (step 506), and thus the payments on Tripartite Mezzanine Loans. Approximately 60% of companies maintain their headquarters office space while under Chapter 11 bankruptcy protection, and affirm their leases in the event of bankruptcy. For this reason, Tripartite Mezzanine Loans 100 are most favorably written against property that are central to the core operation of the tenant's business, rather than facilities that could be readily eliminated in the event of bankruptcy.

In some cases, Tenant 104 may renegotiate (step 510) a reduced rent. Tripartite Mezzanine Loan agreements 140, 150 may require that Borrower 130 negotiate a reaffirmation that at least covers all required cash flows to pay the monthly payment 156 on Tripartite Mezzanine Loan 100, the senior debt service 146 and any expenses 182 to operate and own the building, for example, taxes, insurance, capital improvements, maintenance, and utilities. In the event that Borrower 130 negotiates a rent amount that is insufficient to cover Loan payments 156 (step 512), the loan agreement may provide Tripartite Mezzanine Lender 102 with full recourse to Borrower 130 and Principal Owner 132 (step 514). So, even where Tenant 104 enters bankruptcy, payments 196 on Tripartite Mezzanine Bonds 192 may continue uninterrupted (step 520). In this aspect, Tripartite Mezzanine Bonds 192 may be superior to a corporate bond.

VI.D.2. Re-Letting Vacated Space

In the event that Tenant 104 declares bankruptcy and defaults, but does not reaffirm its lease and vacates the property (step 530), the remaining principal balance of Tripartite Mezzanine Loans 100 may still be timely repaid. Borrower 130 will usually have every incentive to re-lease or re-let the space to another tenant (step 532). In alternatives in which Tripartite Mezzanine Loan agreements 140, 150 require that Borrower 130 assigns any future leases and rent cash flows to the Tripartite Mezzanine cash flow management structure 140, 150, payments 156, 196 will resume on successful re-leasing (step 520). In contrast, with a corporate bond, there is no analogous “substitution” provision.

On average, there is a 75% probability that space vacated by bankrupt Tenant 104 will be re-let in less than 8 months. In some alternatives, Over-Collateralization Account 260 (see § III.B) may provide six to eight months of bond payments 196, depending on the local market conditions. Therefore, as long as Borrower 130 re-lets the space within this time, there may be no default in bond payments 196.

Tripartite Mezzanine Loan structure 100 may retain some element of real estate risk, in that a declining or bad real estate market may reduce the ability of Borrower 130 to re-let the space after a default by Tenant 104, in cases where the lease is terminated or Tenant 104 goes bankrupt and does not reaffirm the lease.

VI.D.3. Default

Thus, there are two scenarios that lead to a default on Tripartite Mezzanine loan payments 156 and bond coupons 196: (a) where Tenant 104 reaffirms the lease at a rent that is insufficient to cover the debt service 156 on Tripartite mezzanine Loan 100 (step 512). In these cases, Tripartite Mezzanine Lender 102 may have recourse against Borrower 130 and/or Principal Owner 132, as discussed in § III.F, and (b) where Tenant 104 rejects the lease and Borrower 130 is unable to re-let the space, and Senior Lender 110 forecloses (step 540). In this case, any excess 542 of the foreclosure price over the principal remaining on Senior Loan 112 may be payable to Tripartite Mezzanine Lender 102.

VI.D.4. Loss Severity

Unless Tripartite Mezzanine Loan 100 is pooled (e.g., as discussed in § II.C) or hedged or otherwise covered (e.g., using one or more of the techniques discussed in § III), the severity of Tripartite Mezzanine Loan 100 is 100% versus the historical average severity of 65-75% for corporate debt obligations. (According to “Default & Recovery Rates of Corporate Bond Issuers,” Moody's (February 2002), the average corporate bond recovery is 35% of the remaining principal balance, drifting downward over the past several years, and varying considerably by industry sector). However, where such coverage has not been provided, Tripartite Mezzanine Lender 102 and Investors 190 may receive a higher coupon whose excess spread may be viewed as the recovery.

Further, a Tripartite Mezzanine Loan 100 may be a fully amortizing loan, while a typical corporate bond pays interest only during its tenor, with 100% of the principal due in the 10th year. Because of the amortization of the balance remaining in the Tripartite Mezzanine structure 100, the expected loss variance between the corporate bonds and a Tripartite Mezzanine Bond 192 may increase over time.

VI.D.5. Recovery

Recovery rates on Tripartite Mezzanine Bonds 192 may be compared to corporate bond default. When a corporation enters bankruptcy, a lengthy process ensues involving the corporate management, the courts and the creditors. After a considerable period of time, the creditors, including the bondholders, receive a percentage of what they are owed. This can vary widely from ultimately receiving 100% of the principal to nothing.

Tripartite Mezzanine Loan 100 recovery may include amounts received from Tenant 104 on reaffirmation of the lease (see, e.g., §§ III.D, VI.D.1), from a successor tenant (see § VI.D.2), from Over-Collateralization Account 260 (see § III.B), from Borrower 130 and/or Principal Owner 132 (see, e.g., §§ III.C and III.F), from insurance and hedging (see, e.g., §§ III.A and III.E.3) and various reserves (see, e.g., § III.H).

Further recovery may be available from residual or “go dark” value of the underlying real estate. In addition, Senior Lender 110, especially on a single-tenant building, may have reserves created from property cash flow to account for leasing commissions and tenant improvement costs. If the “go dark” value of the property plus the value of these reserves exceeds the sum of the balances due on Senior Loan 112 and Tripartite Mezzanine Loan 100, some recovery may flow to Tripartite Mezzanine Lender 102 and to Investors 190. Since Tripartite Mezzanine Loan 100 is subordinate to Senior Loan 112, the probability that these recoveries will be sufficient to pay down both loans is extremely low, although the recovery rate increases over time as Senior Loan 112 and Tripartite Mezzanine Loan 100 amortize.

Additional recovery may be possible in alternatives where Tripartite Mezzanine Lender 102 has access to Tenant 104 as an unsecured subordinate creditor under the assignment 138 of lease, but this amount may be expected to be less than 5%.

VII. Computer Implementation

The payments may be managed by one or more computers. For example, one or more computers may be programmed to generate invoices, payments, statements, and other reports, maintain records, etc. for one or more of the steps described above.

Computer software 250 for originating, managing and analyzing Tripartite Mezzanine Loans 100 may be provided, for example, by Lender 102 or a service bureau affiliated with Lender 102. Such software may improve market efficiencies or capture surpluses in market inefficiencies. The software may further provide electronically integrated loan origination primary and secondary loan transactions, information management, and related services, data storage, risk management, allowing tenants 104 and Owner 132 to consolidate and centralize activities for originating and servicing Tripartite Mezzanine Loans 100. The software may enable tenants, landlords, lenders, brokers or leasing agents, to (a) model a structure for Tripartite Mezzanine Loans 100 in comparison to traditional financing alternatives, (b) apply directly to a lender's credit underwriting department for a loan based upon input provided, (c) receive electronic notification of credit determination, and (d) receive coordination support throughout the closing process. Access to the software may be provided over the internet on a thin client basis, from a central server array, or through other computer access networks. The computer may intermediate a series of vertical and horizontal corollaries in the commercial office and real estate finance markets, including tenant improvement construction loans, real estate and leasing information management, and coordination with other real estate finance markets. Some of the transaction documents may be generated by word processing software.

For the convenience of the reader, the above description has focused on a representative sample of all possible alternatives, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

The invention claimed is:

1. A method, comprising the steps of:
receiving a payment on a junior loan, the junior loan made by a junior lender to an owner of commercial real estate:
ownership of the real estate and of a lease of the real estate being arranged in one or more special-purpose entities bankruptcy remote from obligations unrelated to the real estate, the real estate being under lease from the owner to a tenant;
the owner owing a senior loan to a senior lender and the junior loan to the junior lender, the junior loan collateralized at least in part by a pledge to the lender of rent cash flows generated by the lease and a junior assignment of rents under the lease in lieu of a mortgage foreclosable by the junior lender against the real estate, any ownership interest in any entity with an ownership interest in the real estate, the lessor of the lease, or a tenant of the real estate, except at most in the event of bad boy acts and force majeur events, the junior assignment being junior to any assignment of rents to the senior lender, the junior lender being independent of the senior lender;
the owner having surrendered over to a lockbox arrangement the right to rents paid by the tenant under the lease, the lockbox being obligated to make a senior payment to the senior lender and a junior payment to the junior lender before the owner receives any residual of the lease payments, the junior loan having a payment priority that is senior to all other obligations of the lessor except a senior loan, the lockbox being structured to isolate payment risk to the credit of the tenant, a pricing of the junior loan being based on the credit of the tenant;
the principal of the loan being guaranteed by a financial derivative arranged to cover default of the tenant on rents under the lease;
at least one step of originating, managing or servicing the loan having been performed with the assistance of a computer.

2. A method, comprising the steps of:
receiving a payment on a junior loan, the junior loan owed by an owner of commercial real estate to a junior lender:
ownership of the real estate and of a lease of the real estate being arranged in one or more special-purpose entities bankruptcy remote from obligations unrelated to the real estate, the owner owing a senior loan to a senior lender and the junior loan to the junior lender, the junior lender being independent of the senior lender;
the owner having surrendered over to a lockbox arrangement the right to rents paid by a tenant under the lease, the lockbox being obligated to make a senior payment to the senior lender and a junior payment to the junior lender before the owner receives any residual of the lease payments, the lockbox being structured to isolate payment risk to the credit of the tenant, a pricing of the junior loan being based on the credit of the tenant; and
at least one step of originating, managing or servicing the loan having been performed with the assistance of a computer.

3. The method of claim 2, wherein:
the junior loan is collateralized at least in part by an assignment of rents under the lease junior to any assignment to the senior lender.

4. The method claim 3, wherein:
the junior loan is collateralized without a mortgage foreclosable by the junior lender against the real estate.

5. The method of claim 3, wherein:
the junior loan is guaranteed by a financial derivative arranged to cover default of the tenant on rents under the lease.

6. The method of claim 5, wherein:
the financial derivative is a credit default swap.

7. The method of claim 3, wherein:
the owner has covenanted under the terms of the junior loan, in the event of default by the tenant, to surrender rents under any replacement lease to the lockbox arrangement.

8. The method of claim 2, wherein:
the junior loan is guaranteed by a financial derivative arranged to cover default of the tenant on rents under the lease.

9. The method of claim 8, wherein:
the financial derivative is a credit default swap.

10. The method of claim 3, wherein:
the owner has covenanted under the terms of the junior loan, in the event of default by the tenant, to surrender rents under any replacement lease to the lockbox arrangement.

11. The method of claim 3, wherein:
the lockbox arrangement includes two different servicers or custodians of different depository accounts for servicing the junior and senior loans, respectively.

12. The method of claim 3, wherein:
a single servicer makes the payments to the senior and junior lenders from a single depository account.

13. The method of claim 3, wherein:
the lockbox arrangement further makes a payment for operating expenses or taxes before the owner receives any residual of the lease payments.

14. The method of claim 3, wherein:
the terms of the junior loan have the effect of imposing requirements on the tenant in event the tenant enters bankruptcy and reaffirms the lease.

15. The method of claim 3, wherein:
the terms of the lease obligate the tenant to continue to pay rent in the case of at least a partial condemnation taking, and terms of the loan provide recovery to the junior lender against any recovery by tenant or landlord for the condemnation.

16. The method of claim 3, wherein:
the lease is a single-tenant lease.

17. The method of claim 3, wherein:
the real estate is a multi-tenant property, and the owner has surrendered over to a lockbox arrangement the right to rents paid by several tenants of the real estate.

18. The method of claim 2, wherein:
the lockbox arrangement includes two different servicers or custodians of different depository accounts for servicing the junior loan and senior financing, respectively.

19. The method of claim 2, wherein:
a single servicer makes the payments to the senior and junior lenders from a single depository account.

20. The method of claim 2, wherein:
the lockbox arrangement further makes a payment for operating expenses or taxes before the owner receives any residual of the lease payments.

21. The method of claim 2, wherein:
the terms of the junior loan have the effect of imposing requirements on the tenant in event the tenant enters bankruptcy and reaffirms the lease.

22. The method of claim 2, wherein:
the terms of the lease obligate the tenant to continue to pay rent in the case of at least a partial condemnation taking, and terms of the loan provide recovery to the junior lender against any recovery by tenant or landlord for the condemnation.

23. The method of claim 2, wherein:
the lease is a single-tenant lease.

24. The method of claim 2, wherein:
the real estate is a multi-tenant property, and the owner has surrendered over to a lockbox arrangement the right to rents paid by several tenants of the real estate.

25. The method of claim 3, further comprising the step of:
the junior lender issuing obligations backed by the payments from the lockbox arrangement.

26. The method of claim 25, wherein:
the obligations include a private placement participating or syndicating the loan.

27. The method of claim 25, wherein:
the obligations include a publicly-issued security.

28. The method of claim 25, further comprising the step of:
reserving at least part of the junior payment for an over-collateralization account for the protection of the obligations.

29. The method of claim 25, wherein:
the junior lender secures a put, short, swap, insurance, or other protection against default of the tenant.

30. A method, comprising the steps of:
advancing a junior loan from a junior lender to an owner of commercial real estate, ownership of the real estate and of a lease of the real estate being arranged in one or more special-purpose entities bankruptcy remote from obligations unrelated to the real estate, the owner owing a senior loan to a senior lender and the junior loan to the junior lender, the junior lender being independent of the senior lender;
the owner surrendering over to a lockbox arrangement the right to rents paid under the lease, the lockbox being obligated to make a senior payment to the senior lender and a junior payment to the junior lender before the owner receives any residual of the lease payments, the lockbox being structured to isolate payment risk to the credit of the tenant, a pricing of the junior loan being based on the credit of the tenant;
at least one step of originating, managing or servicing the loan being performed with the assistance of a computer.

31. The method of claim 30, wherein:
the junior loan is collateralized at least in part by a pledge to the lender of rent cash flows generated by a lease of the real estate.

32. The method of claim 21, wherein:
the terms of the junior loan are non-recourse against the real estate, the lessor of the lease, or a tenant of the real estate, except at most in the event of bad boy acts and force majeur events.

33. The method of claim 30, wherein:
the junior lender has obtained financing based on the credit of the tenant of the lease.

34. The method of claim 30, further comprising the step of:
the owner has covenanting under the terms of the junior loan, in the event of default by the tenant, to surrender rents under any replacement lease to the lockbox arrangement.

35. The method of claim 30, wherein:
the lockbox arrangement includes two different servicers or custodians of different depository accounts for servicing the junior and senior loans, respectively.

36. The method of claim 30, wherein:
the junior loan is advanced after the senior loan.

37. The method of claim 30, wherein:
the junior loan is advanced contemporaneously with the senior loan.

38. The method of claim 30, wherein:
the terms of the lease obligate the tenant to continue to pay rent in the case of at least a partial condemnation taking, and terms of the loan provide recovery to the junior lender against any recovery by tenant or landlord for the condemnation.

39. The method of claim 30, wherein:
the real estate is a multi-tenant property, and the owner has surrendered over to a lockbox arrangement the right to rents paid by several tenants of the real estate.

40. The method of claim 30, further comprising the step of:
the junior lender issuing obligations backed by the payments from the lockbox arrangement.

41. A method, comprising the steps of:
receiving a payment on a junior loan, the loan made by a junior lender to an owner of commercial real estate, the owner owing a senior loan to a senior lender and the junior loan to the junior lender, the junior lender being independent of the senior lender, the junior loan collateralized at least in part by a junior assignment of rents under the lease in lieu of a mortgage foreclosable by the junior lender against the real estate, the junior assignment being junior to any assignment of rents to the senior lender;
at least one step of originating, managing or servicing the loan having been performed with the assistance of a computer.

42. The method of claim 41, wherein:
the junior loan is guaranteed by a financial derivative arranged to cover default of the tenant on rents under the lease.

43. The method of claim 42, wherein:
the financial derivative is a credit default swap.

44. The method of claim 41, wherein:
an owner of the real estate and of a lease of the real estate has surrendered over to a lockbox arrangement the right to rents paid under the lease, the lockbox being obligated to make a senior payment to a senior lender and a junior payment to the junior lender before the owner receives any residual of the lease payments.

45. The method of claim 44, wherein:
the junior loan is collateralized neither by a pledge nor a lien over the real estate nor against any ownership interest in any entity with an ownership interest in the real estate, except at most in the event of bad boy acts and force majeur events.

46. The method of claim 44, wherein:
the terms of the junior loan are non-recourse against the real estate, the lessor of the lease, or a tenant of the real estate, except at most in the event of bad boy acts and force majeur events.

47. The method of claim 44, wherein:
the junior loan has a payment priority that is senior to all other obligations of the owner except a senior loan.

48. The method of claim 41, wherein:
the owner has covenanted under the terms of the junior loan, in the event of default by the tenant, to surrender rents under any replacement lease to the lockbox arrangement.

49. The method of claim 41, wherein:
the lockbox arrangement includes two different servicers or custodians of different depository accounts for servicing the junior and senior loans, respectively.

50. The method of claim 41, wherein:
the lockbox arrangement further makes a payment for operating expenses or taxes before the owner receives any residual of the lease payments.

51. The method of claim 41, wherein:
the terms of the junior loan have the effect of imposing requirements on the tenant in event the tenant enters bankruptcy and reaffirms the lease.

52. A method, comprising the steps of:
advancing a junior loan from a junior lender to an owner of commercial real estate, the owner owing a senior loan to a senior lender and the junior loan to the junior lender, the junior lender being independent of the senior lender, the junior loan collateralized at least in part by a junior assignment of rents under the lease in lieu of a mortgage foreclosable by the junior lender against the real estate, the junior assignment being junior to any assignment of rents to the senior lender;
at least one step of originating, managing or servicing the loan being performed with the assistance of a computer.

53. The method of claim 52, wherein:
an interest rate of the junior loan is based on the credit of the tenant.

54. The method of claim 52:
wherein ownership of the real estate and of a lease of the real estate being are arranged in one or more special-purpose entities bankruptcy remote from obligations unrelated to the real estate;
and further comprising the step of the owner surrendering over to a lockbox arrangement the right to rents paid under the lease, the lockbox being obligated to make a senior payment to the senior lender and a junior payment to the junior lender before the owner receives any residual of the lease payments, the lockbox being structured to isolate payment risk to the credit of the tenant.

55. The method of claim 52, further comprising the step of:
the owner has covenanting under the terms of the junior loan, in the event of default by the tenant, to surrender rents under any replacement lease to the lockbox arrangement.

56. The method of claim 52, wherein:
a single servicer makes the payments to the senior and junior lenders from a single depository account.

57. The method of claim 52, wherein:
the junior loan is advanced after the senior loan.

58. The method of claim 52, wherein:
the junior loan is advanced contemporaneously with the senior loan.

59. The method of claim 52, wherein:
the terms of the lease obligate the tenant to continue to pay rent in the case of at least a partial condemnation taking, and terms of the loan provide recovery to the junior lender against any recovery by tenant or landlord for the condemnation.

60. The method of claim 52, wherein:
the lease is a single-tenant lease.

61. The method of claim 52, wherein:
the real estate is a multi-tenant property, and the owner has surrendered over to a lockbox arrangement the right to rents paid by several tenants of the real estate.

62. The method of claim 52, further comprising the step of:
the junior lender issuing obligations backed by the payments from the lockbox arrangement.

63. The method of claim 62, wherein:
the obligations include a private placement participating or syndicating the loan.

64. The method of claim 62, wherein:
the obligations include a publicly-issued security.

65. The method of claim 62, further comprising the step of:
reserving at least part of the junior payment for an over-collateralization account for the protection of the obligations.

66. The method of claim 62, wherein:
the junior lender secures a put, short, swap, insurance, or other protection against default of the tenant.

67. A method, comprising the steps of:
receiving a payment on a loan, the loan made by a lender to an owner of commercial real estate, the real estate being under lease from the owner to a tenant, payments of the loan being secured by payments under the lease, the loan being guaranteed by a financial derivative arranged to cover default of the tenant on rents under the lease;
at least one step of originating, managing or servicing the loan having been performed with the assistance of a computer.

68. The method of claim 67, wherein:
the financial derivative is a credit default swap.

69. The method of claim 67, wherein:
the loan covered by the financial derivative is a junior loan, and the lender is a junior lender, the asset encumbered by a senior financing from a senior lender.

70. The method of claim 69, wherein:
the asset is an interest in commercial real estate.

71. The method of claim 67, wherein:
the loan covered by the financial derivative is a junior loan, and the lender is a junior lender, the owner owing a senior loan to a senior lender.

72. The method of claim 57, wherein:
the financial derivative is a credit default swap.

73. The method of claim 57, wherein:
wherein an owner of the real estate and of a lease of the real estate has surrendered over to a lockbox arrangement the right to rents paid under the lease, the lockbox being obligated to make a senior payment to a senior lender and a junior payment to the junior lender before the owner receives any residual of the lease payments.

74. The method of claim 73, wherein:
the junior loan is collateralized neither by a pledge nor a lien over the real estate nor against any ownership interest in any entity with an ownership interest in the real estate, except at most in the event of bad boy acts and force majeur events.

75. The method of claim 73, the terms of the junior loan being non-recourse against the real estate, the lessor of the lease, or a tenant of the real estate, except at most in the event of bad boy acts and force majeur events.

76. The method of claim 73, wherein:
the junior loan has a payment priority that is senior to all other obligations of the owner except a senior loan.

77. The method of claim 57, wherein:
the owner has covenanted under the terms of the junior loan, in the event of default by the tenant, to surrender rents under any replacement lease to the lockbox arrangement.

78. The method of claim 57, wherein:
the terms of the lease obligate the tenant to continue to pay rent in the case of at least a partial condemnation taking, and terms of the loan provide recovery to the junior lender against any recovery by tenant or landlord for the condemnation.

79. The method of claim 57, wherein:
the lease is a single-tenant lease.

80. The method of claim 57, wherein:
the real estate is a multi-tenant property, and the owner has surrendered over to a lockbox arrangement the right to rents paid by several tenants of the real estate.

81. A method, comprising the steps of:
originating a loan from a lender to an owner of commercial real estate, the real estate being under lease from the owner to a tenant, payments of the loan being secured by payments under the lease, the principal of the loan being guaranteed by a financial derivative arranged to cover default of the tenant on rents under the lease;
at least one step of originating, managing or servicing the loan being performed with the assistance of a computer.

82. The method of claim 81, wherein:
the financial derivative is a credit default swap.

83. The method of claim 81, wherein:
the loan covered by the financial derivative is a junior loan, and the lender is a junior lender, the owner owing a senior loan to a senior lender.

84. The method of claim 83, wherein:
the financial derivative is a credit default swap.

85. The method of claim 83, wherein:
an interest rate of the junior loan is based on the credit of the tenant.

86. The method of claim 83, further comprising the step of the owner surrendering over to a lockbox arrangement the right to rents paid under the lease, the lockbox being obligated to make a senior payment to the senior lender and a junior payment to the junior lender before the owner receives any residual of the lease payments, the lockbox being structured to isolate payment risk to the credit of the tenant, a pricing of the junior loan being based on the credit of the tenant.

87. The method of claim 83, wherein:
the junior loan is collateralized at least in part by a junior assignment of rents under the lease in lieu of a mortgage foreclosable by the junior lender against the real estate, the junior assignment being junior to any assignment of rents to the senior lender.

88. The method of claim 81, wherein:
the terms of the junior loan have the effect of imposing requirements on the tenant in event the tenant enters bankruptcy and reaffirms the lease.

89. The method of claim 81, further comprising the step of:
the junior lender issuing obligations backed by the payments from the lockbox arrangement.

90. The method of claim 89, wherein:
the obligations include a private placement participating or syndicating the loan.

91. The method of claim 89, wherein:
the obligations include a publicly-issued security.

92. The method of claim 89, further comprising the step of:
reserving at least part of the junior payment for an over-collateralization account for the protection of the obligations.

93. The method of claim 89, wherein:
the junior lender secures a put, short, swap, insurance, or other protection against default of the tenant.

94. A method, comprising the steps of:
receiving a payment on a junior loan, the loan made by a junior lender to an owner of commercial real estate, payments of the loan being secured by payments under a lease of the real estate:
an owner of the real estate and of the lease of the real estate having surrendered over to a lockbox arrangement the right to rents paid under the lease, the lockbox being obligated to make a senior payment to a senior lender and a junior payment to the junior lender before the owner receives any residual of the lease payments; and
the junior loan collateralized by a pledge to the lender of rent cash flows generated by a lease of the real estate, and neither a pledge nor a lien over the real estate nor against any ownership interest in any entity with an ownership interest in the real estate, except at most in the event of bad boy acts and force majeur events;
at least one step of originating, managing or servicing the loan having been performed with the assistance of a computer.

95. The method of claim 94, wherein:
an interest rate of the junior loan is based on the credit of the tenant.

96. The method of claim 94:
wherein ownership of the real estate and of a lease of the real estate being are arranged in one or more special-purpose entities bankruptcy remote from obligations unrelated to the real estate; and
the lockbox is structured to isolate payment risk to the credit of the tenant;
an interest rate on the junior loan being based on the credit of the tenant.

97. The method of claim 94, wherein:
the owner has covenanted under the terms of the junior loan, in the event of default by the tenant, to surrender rents under any replacement lease to the lockbox arrangement.

98. The method of claim 94, wherein:
the terms of the junior loan have the effect of imposing requirements on the tenant in event the tenant enters bankruptcy and reaffirms the lease.

99. The method of claim 94, further comprising the step of:
the junior lender issuing obligations backed by the payments from the lockbox arrangement.

100. The method of claim 94, wherein:
the junior loan is further collateralized by a financial derivative arranged to cover default of the tenant on rents under the lease.

101. The method of claim 100, wherein:
the financial derivative is a credit default swap.

102. A method, comprising the steps of:
advancing a junior loan of funds from a lender to an owner of an interest in real estate, the junior loan being subordinate to a senior financing of the real estate, the junior loan being collateralized by a pledge to the lender of rent cash flows generated by a lease of the real estate, the lender taking neither a pledge of nor a lien over the real estate nor against any ownership interest in any entity with an ownership interest in the real estate, except at most in the event of bad boy acts and force majeur events;
at least one step of originating, managing or servicing the loan being performed with the assistance of a computer.

103. The method of claim 102, wherein:
the junior loan is collateralized at least in part by a junior assignment of rents under the lease in lieu of a mortgage foreclosable by the junior lender against the real estate, the junior assignment being junior to any assignment of rents to the senior lender.

104. The method of claim 102, wherein:
the junior loan is further collateralized by a financial derivative arranged to cover default of the tenant on rents under the lease.

105. The method of claim 104, wherein:
the financial derivative is a credit default swap.

106. The method of claim 102, the owner further surrendering right to residual lease payments until the lockbox arrangement has further made a payment for operating expenses or taxes.

107. The method of claim 102, wherein:
the terms of the lease obligate the tenant to continue to pay rent in the case of at least a partial condemnation taking, and terms of the loan provide recovery to the junior lender against any recovery by tenant or landlord for the condemnation.

108. The method of claim 102, wherein:
the lease is a single tenant lease.

109. A method, comprising the steps of:
advancing a junior loan of funds from a lender to an owner of an interest in real estate, the junior loan being subordinate to a senior financing of the real estate, the junior loan being collateralized by a pledge to the junior lender of rent cash flows generated by a lease of the real estate, the terms of the junior loan being non-recourse against the real estate, the owner, or a tenant of the real estate, except at most in the event of bad boy acts and force majeur events;
at least one step of originating, managing or servicing the junior loan being performed with the assistance of a computer.

110. The method of claim 109:
wherein ownership of the real estate and of a lease of the real estate being are arranged in one or more special-purpose entities bankruptcy remote from obligations unrelated to the real estate;
and further comprising the step of the owner surrendering over to a lockbox arrangement the right to rents paid under the lease, the lockbox being obligated to make a senior payment to the senior lender and a junior payment to the junior lender before the owner receives any residual of the lease payments, the lockbox being structured to isolate payment risk to the credit of the tenant.

111. The method of claim 109, wherein:
the junior loan is collateralized at least in part by an assignment of rents under the lease junior to any assignment to the senior lender.

112. The method of claim 109, wherein:
the junior loan is guaranteed by a financial derivative arranged to cover default of the tenant on rents under the lease.

113. The method of claim 112, wherein:
the financial derivative is a credit default swap.

114. The method of claim 109, wherein:
an interest rate of the junior loan is based on the credit of the tenant.

115. The method of claim 109, further comprising the step of:
the owner has covenanting under the terms of the junior loan, in the event of default by the tenant, to surrender rents under any replacement lease to the lockbox arrangement.

116. The method of claim 109, the owner further surrendering right to residual lease payments until the lockbox arrangement has further made a payment for operating expenses or taxes.

117. The method of claim 109, wherein:
the terms of the junior loan have the effect of imposing requirements on the tenant in event the tenant enters bankruptcy and reaffirms the lease.

118. A method, comprising the steps of:
advancing a junior loan of funds from a junior lender to a owner of an interest in real estate, the junior loan having a payment priority that is senior to all other obligations of the owner except a senior loan, the junior lender being independent of a senior lender of the senior loan, terms of the junior loan being non-recourse against the real estate, the owner, or a tenant of the real estate except at most bad boy acts and force majeur events;
at least one step of originating, managing or servicing the loan being performed with the assistance of a computer.

119. The method of claim 118, wherein:
the lockbox arrangement includes two different servicers or custodians of different depository accounts for servicing the junior and senior loans, respectively.

120. The method of claim 118, wherein:
the terms of the junior loan have the effect of imposing requirements on the tenant in event the tenant enters bankruptcy and reaffirms the lease.

121. The method of claim 118, wherein:
the terms of the lease obligate the tenant to continue to pay rent in the case of at least a partial condemnation taking, and terms of the loan provide recovery to the junior lender against any recovery by tenant or landlord for the condemnation.

122. The method of claim 118, wherein:
the lease is a single-tenant lease.

123. The method of claim 118, wherein:
the real estate is a multi-tenant property, and the owner has surrendered over to a lockbox arrangement the right to rents paid by several tenants of the real estate.

124. A method, comprising the steps of:
lending funds to create a junior loan from a lender to a owner of real estate, the real estate being under lease from the owner to a tenant, the junior loan being subordinate to a senior loan owed by the owner, the junior lender being independent of a senior lender of the senior loan, an interest rate of the junior loan being based on the credit of the tenant;
at least one step of originating, managing or servicing the loan being performed with the assistance of a computer.

125. The method of claim 124, the owner having surrendered over to a lockbox arrangement the right to rents paid by a tenant under the lease, the lockbox being obligated to make a senior payment to a senior lender of the senior loan and a junior payment to the junior lender before the owner receives any residual of the lease payments.

126. The method of claim 125:
ownership of the real estate and of a lease of the real estate being arranged in one or more special-purpose entities bankruptcy remote from obligations unrelated to the real estate.

127. The method of claim 125, wherein:
the junior loan is collateralized at least in part by a junior assignment of rents under the lease, the junior assignment being junior to any assignment of rents to the senior lender.

128. The method of claim 127, wherein:
the financial derivative is a credit default swap.

129. The method of claim 124, wherein:
the junior loan is collateralized by a pledge to the junior lender of rent cash flows generated by a lease of the real estate, in lieu of a pledge of or a lien over the real estate nor against any ownership interest in any entity with an ownership interest in the real estate, except at most in the event of bad boy acts and force majeur events.

130. The method of claim 124, wherein:
the junior loan is collateralized by a pledge to the junior lender of rent cash flows generated by a lease of the real estate, the terms of the junior loan being non-recourse against the real estate, the lessor of the lease, or a tenant of the real estate, except at most in the event of bad boy acts and force majeur events.

131. The method of claim 124, the junior loan having a payment priority that is senior to all other obligations of the owner except a senior financing, terms of the loan being non-recourse against the real estate, the owner, or a tenant of the real estate except at most bad boy acts and force majeur events.

132. The method of claim 124, wherein:
the junior loan is advanced after the senior financing.

133. The method of claim 124, wherein:
the junior loan is advanced contemporaneously with the senior financing.

134. The method of claim 124, wherein:
the terms of the junior loan have the effect of imposing requirements on the tenant in event the tenant enters bankruptcy and reaffirms the lease.

135. The method of claim 124, wherein:
the terms of the lease obligate the tenant to continue to pay rent in the case of at least a partial condemnation taking, and terms of the loan provide recovery to the junior lender against any recovery by tenant or landlord for the condemnation.

136. The method of claim 125, wherein:
the loan is guaranteed by a financial derivative arranged to cover default of the tenant on rents under the lease.

137. The method of claim 136, wherein:
the financial derivative is a credit default swap.

138. The method of claim 125, wherein:
the junior loan is collateralized by a pledge to the lender of rent cash flows generated by a lease of the real estate, in lieu of a pledge of or a lien over the real estate nor against any ownership interest in any entity with an ownership interest in the real estate, except at most in the event of bad boy acts and force majeur events.

139. The method of claim 125, wherein:
the junior loan is collateralized by a pledge to the lender of rent cash flows generated by a lease of the real estate, the terms of the junior loan being non-recourse against the real estate, the lessor of the lease, or a tenant of the real estate, except at most in the event of bad boy acts and force majeur events.

140. The method of claim 125, the junior loan having a payment priority that is senior to all other obligations of the owner except a senior loan, terms of the loan being non-recourse against the real estate, the owner, or a tenant of the real estate except at most bad boy acts and force majeur events.

141. The method of claim 124, wherein:
the junior loan is advanced after the senior loan.

142. The method of claim 124, wherein:
the junior loan is advanced contemporaneously with the senior loan.

143. The method of claim 124, wherein:
the terms of the junior loan have the effect of imposing requirements on the tenant in event the tenant enters bankruptcy and reaffirms the lease.

144. The method of claim 124, wherein:
the terms of the lease obligate the tenant to continue to pay rent in the case of at least a partial condemnation taking, and terms of the loan provide recovery to the junior lender against any recovery by tenant or landlord for the condemnation.

145. The method of claim 124, further comprising the step of:
the junior lender issuing obligations backed by the payments from the lockbox arrangement.

146. The method of claim 145, wherein:
the obligations include a private placement participating or syndicating the loan.

147. The method of claim 145, wherein:
the obligations include a publicly-issued security.

148. The method of claim 145, further comprising the step of:
reserving at least part of the junior payment for an over-collateralization account for the protection of the obligations.
